(19) United States
(12) Patent Application Publication
(10) Pub. No.: US 2014/0245165 A1
(43) Pub. Date: Aug. 28, 2014

(54) SYSTEMS AND METHODS FOR COLLECTING AND REPRESENTING ATTRIBUTES RELATED TO DAMAGE IN A GEOGRAPHIC AREA

(71) Applicant: Donan Engineering Co., Inc., Louisville, KY (US)

(72) Inventors: Duane Michael Battcher, Prospect, KY (US); James Lyle Donan, Anchorage, KY (US); Russell A. Zeckner, Louisville, KY (US); Leslie Noel, Louisville, KY (US)

(73) Assignee: Donan Engineering Co., Inc., Louisville, KY (US)

(21) Appl. No.: 14/187,207

(22) Filed: Feb. 21, 2014

Related U.S. Application Data
(63) Continuation-in-part of application No. 13/779,865, filed on Feb. 28, 2013.

(51) Int. Cl. G06F 3/0484

(52) U.S. Cl. CPC G06F 3/04842
USPC 715/738

(57) ABSTRACT

Methods and apparatus related to representing damage related attributes. A target geographic area potentially affected by an event may be identified. An interactive map of the target geographic area may be identified. A selectable option for selection of at least one attribute may be provided, the at least one attribute including one or more of at least one radar characteristic based on data from weather radar, at least one event characteristic based on field data, data related to one or more objects in the target geographic area, at least one damage characteristic identifying potential damage to a given object, a damage likelihood, a damage level, and a confidence level associated with the damage assessment and indicative of confirmation of the field data. The selection of the at least one attribute may be identified. The selected at least one attribute may be provided with the interactive map.

### CROSS REFERENCE TO RELATED APPLICATIONS AND CLAIM TO PRIORITY

This application is a continuation-in-part of, and claims priority to and benefit under 35 U.S.C. §120 the prior-filed and co-pending U.S. non-provisional Application Ser. No. 13/779,865 filed on Feb. 28, 2013, entitled “Systems and methods for collecting and representing field data in disaster affected areas,” the disclosure of which is incorporated by reference herein in its entirety.

### STATEMENT REGARDING FEDERALLY SPONSORED RESEARCH

None.

### REFERENCE TO SEQUENTIAL LISTING, ETC.

None.

### BACKGROUND

Present embodiments are related to systems and methods for gathering and presenting information pertaining to weather related event and correlating it to available data from weather reporting systems. Additional embodiments are related to systems and methods related to representing damage related attributes.

Storms cause physical damage to various properties. In order to efficiently validate and process property damage claims, insurance companies, state and federal agencies, and/or other organizations, need to verify both the geographical boundary of the affected area, and the type and extent of damage to individual properties within the area. The volume of post event claims is typically high. Therefore, it is desirable to have a system and method for collecting and representing field data in a disaster affected area in order to more easily verify the affected geographic area and provide details regarding the extent of damage within that area so that users, such as insurance companies, can reduce the strain on their financial and human resources.

### SUMMARY

The specification describes a system and method relating to information gathering of event characteristics pertaining to weather related events and correlating these to available data from weather reporting systems.

In general, one aspect of the technology described can be embodied in methods that include identifying a target geographic area potentially affected by a disaster event, and identifying event characteristics. The method further includes providing a database with at least one initial attribute of the target area. The method further includes communicating with at least one source to obtain field data related to the disaster event, and updating the database with the field data. The method further includes generating at least one augmented attribute of the target area based on a synthesis of the field data in the database. A representation of the at least one augmented attribute is then stored.

In some implementations, the representation of the augmented attribute may be a visual representation, and in some implementations, the visual representation may include a map of the target geographic area. In some implementations, the at least one initial attribute may include an initial map of the target geographic area. The visual representation may include an augmented map of the target geographic area based on the event characteristics. In some implementations, the at least one target geographic area may be obtained from a weather data system. The weather data system may include one or more of a Doppler radar weather system, pulse-Doppler radar weather system, and a weather data provider vendor. In some implementations, the at least one target geographic area may be obtained from a social media platform.

The disaster event may be a weather-related event including a thunderstorm, tornado, snowstorm, hailstorm, lightning, drought, or fire. The disaster event may further be a hailstorm and the event characteristics may include factors such as the average size of the hail, the affected geographical area, the time length of the storm, the typical size of hail impact, the damage to property, or the wind velocities. The disaster event may be a natural disaster event including an earthquake, tsunami, flood, or volcano.

The field data may include data from field personnel deployed in the target geographic area or data captured through one or more social media platforms. The at least one source providing the field data may be a field personnel. Communication may include communication using a mobile device.

In some implementations, the database may be updated with field data including automated receipt and update of data, including data from field deployed remote sensors, cartographic cameras, aerial reconnaissance systems, or satellite images. In yet other implementations, the updating of the database with the field data may include iterative updating of the database at pre-determined time intervals.

These and additional embodiments can include a system and method for collecting and representing event characteristics for one or more of the following disaster events: a weather related event (e.g., thunderstorm, tornado, snowstorm, hailstorm, lightning, drought, fires), a natural disaster event (e.g., earthquake, tsunami, floods, volcanoes), and/or a human induced event (e.g., wars, fires).

Event characteristics may include identifying data from one or more weather data systems, feeds from social media like Facebook, Twitter, feeds from television signals, photographs of the damage, sampling of field data pertaining to the size, spread and magnitude of impact characteristics, geo-position markers for event impact areas, real-time reading of humidity, pressure, temperature, wind velocity, water level, etc. Field deployment can include manual deployment of personnel to document event characteristics, or field data collection through remote techniques, including aerial photographs, use of cartographic cameras, and/or satellite images. Event characteristics may be documented using preset data forms. The collection of field data may be user-interfaced via a specialized web page or a mobile application to provide efficient access to personnel deployed in the field. The system may also be configured to synchronize other field deployment techniques and/or mobile devices. The system itself may be hosted by one or more servers, including a cloud server. Specified post-event time intervals to retrieve and update data may vary according to the type of event, the event characteristics, or accessibility to the event area.

In some implementations, the representation of the one or more augmented attributes may include representation on a display device. In some implementations, this representation may be in the form of a real-time mapping of the affected area. In some implementations, such a map may be an interactive display with icons and menus that are capable of providing further data, and/or provide access to location specific images, audio, video, and related documents. The specialized maps displaying the field data may be interactive, offering different levels of detail, 2-D, 3-D or satellite views, populated with positional icons with field data, and/or contour mapping. One or more augmented attributes from the database may be sent to vendors such as weather systems, mapping services, or television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written description of the affected geographic area. These maps may be available to end-users in either electronic form, for example by way of email, specialized web pages, or mobile applications, or by written or typed document.

Other implementations may include a disaster identification and management system comprising a communication and monitoring environment in optional combination with one or more weather data systems, wherein the communication and monitoring environment comprises communication infrastructure capable of data exchange from and between central command or distributed information resources and a plurality of client devices in the field. Yet another implementation may include a non-transitory computer readable storage medium storing computer instructions executable by a processor to perform the various methods described herein.

In general, one aspect of the technology described can be embodied in methods that include retrieving and updating real-time, on-site data pertaining to event characteristics. This may be accomplished via field deployment. This data is then uploaded to the system and correlated to and synthesized with available metrics from weather reporting systems to create specialized maps. The retrieval and update of data is achieved over specified post-event time intervals, as needed, thus allowing the system to refine and update the specialized maps.

Another aspect of the technology disclosed is an implementation of a system to realize one or more of the following advantages. The system can learn from past field and weather observations to suggest specific data retrieval by field personnel.

The details of one or more embodiments of the technology disclosed in this specification are set forth in the accompanying drawings and the description below. Additional features, aspects, and advantages of the technology disclosed will become apparent from the description, the drawings and the claims.

### BRIEF DESCRIPTION OF THE DRAWINGS

FIG. 1 illustrates a block diagram of an example communication and monitoring process environment in optional combination with one or more weather data systems.

FIG. 2 illustrates a block diagram of an example central command module within the communication and monitoring process environment.

FIG. 3 illustrates a flow diagram of an example process that includes a feed from a weather data system.

FIG. 4 illustrates a block diagram of an example post event periodic retrieval and update process.

FIG. 5 illustrates a block diagram of an example communication and monitoring process environment.

FIG. 6 illustrates a flow diagram of an example process that does not include a feed from a weather data system.

FIG. 7A illustrates an example of an initial attribute, specifically a map based on a feed from a weather data system indicating a hailstorm in a geographic area.

FIG. 7B illustrates an example of an initial attribute, specifically an initial map representing projected hailstone sizes.

FIG. 7C illustrates an example of an initial attribute, specifically an initial map representing a data collection grid to capture event characteristics.

FIG. 7D illustrates an example of a representation of an augmented attribute, specifically an augmented map representing actual hailstone sizes based upon a synthesis of field data.

FIG. 8A illustrates an example of an interactive map of a target geographic area.

FIG. 8B illustrates another example of an interactive map, including a selectable option associated with at least one attribute.

FIG. 9A illustrates an example of a selectable option associated with the at least one event characteristic.

FIG. 9B illustrates an example of a selectable option associated with the at least one radar characteristic.

FIG. 9C illustrates an example of a selectable option associated with a damage level.

FIG. 9D illustrates an example of a selectable option associated with a confidence level.

FIG. 9E illustrates another example of a selectable option associated with at least one attribute.

FIG. 10A illustrates an example of an interactive map including a selection of at least one attribute.

FIG. 10B illustrates another example of an interactive map including a selection of at least one attribute.

FIG. 11A illustrates an example of an interactive map including a report based on at least one attribute.

FIG. 11B illustrates an example report.

FIG. 12 illustrates an example of an interactive map including field data and a confidence level.

FIG. 13 illustrates an example of an interactive map including confidence levels represented as contour lines.

FIG. 14 illustrates an example of an interactive map including the at least one event characteristic.

FIG. 15 illustrates an example of an interactive map including a comparison of at least one radar characteristic and at least one event characteristic.

FIG. 16 illustrates a flow diagram of an example process for providing damage assessment.

### DETAILED DESCRIPTION

The embodiments herein are generally directed to a system and method for integrating ground-level field observations from a disaster hit area with disaster related data obtained from an independent source and representing this information on an augmented map. The map itself may be tagged, annotated and/or accompanied by menus, icons, photographs, text, and audio, related to the disaster event.

In general, one aspect of the technology described can be embodied in methods that include identifying a target geographic area potentially affected by a disaster event, and identifying event characteristics. The method further includes providing a database with at least one initial attribute of the target area. The method further includes communicating with at least one source to obtain field data related to the disaster event, and updating the database with the field data. The method further includes generating at least one augmented attribute of the target area based on a synthesis of the field data in the database. A representation of the at least one augmented attribute is then stored.

Generally speaking, one or more systems may be configured to receive signals from an independent weather data system about a current, imminent or potential disaster and identify a target geographic area based on these signals. Additional information and data about event characteristics may be received from one or more clients and vendors within the target area. A preliminary map of the target area may then be formed. The system then receives field data related to the disaster event from a plurality of sources within the target geographic area. As such localized and ground-level field data is received, the system may be generally configured to populate a database and outlay this updated information onto the preliminary map of the target area. As more data is received, from the field and optionally from independent weather data systems, the preliminary map is filled in with augmented details. A preliminary map of a target area morphs into an augmented map representing the scope and dimension of the disaster. The extent of physical damage to property may then be directly observed from the collected field data and/or inferred from available statistical and technical data about the extent and type of damage from a disaster of given scope and dimension. This augmented map is then provided to clients such as insurance companies who may, in a particular instance, determine the validity of an individual insurance claim based on the physical location of the subject property within the augmented map. For instance, insurance companies may validate all claims from a particular area falling within an identified region on the augmented map, where the region is identified because the texturing suggests a high probability that damage was incurred by subject property due to the disaster related event. Likewise, the insurance company may further investigate those claims from properties that are outside this identified region. Finally, this frees up the insurance companies' limited resources to pursue the legitimacy of claims from properties that lie in an ambiguous region within the augmented area. The details in the augmented map may further provide collateral indicators to determine if a claim was a result of a disaster event or another cause.

Additional embodiments may be directed to methods and apparatus related to representing damage related attributes. A target geographic area potentially affected by an event may be identified. An interactive map of the target geographic area may be identified. A selectable option for selection of at least one attribute may be provided, the at least one attribute including one or more of at least one radar characteristic based on data from weather radar, at least one event characteristic based on field data, data related to one or more objects in the target geographic area, at least one damage characteristic identifying potential damage to a given object, a damage likelihood, a damage level, and a confidence level associated with the damage assessment and indicative of confirmation of the field data. The selection of the at least one attribute may be identified. The selected at least one attribute may be provided with the interactive map.

These and other particular embodiments will be described in more detail with the help of figures.

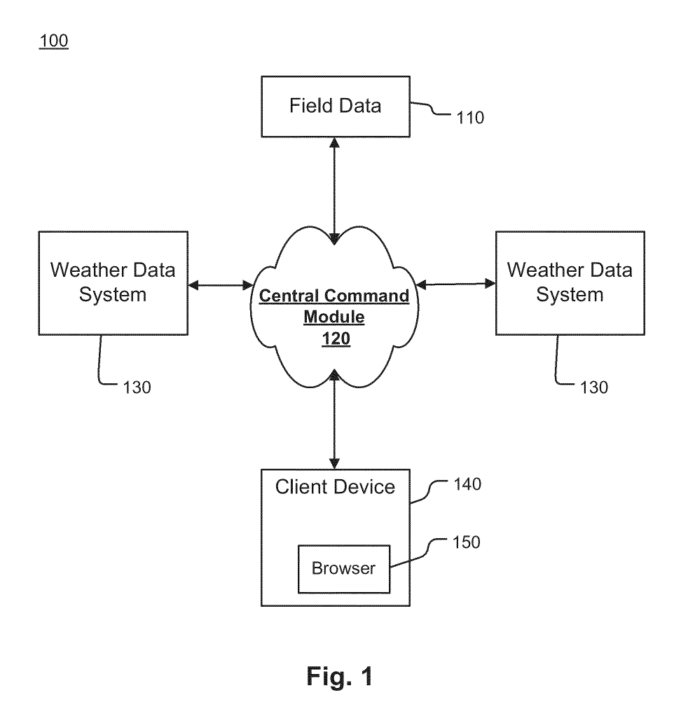

FIG. 1 illustrates a block diagram of an example communication and monitoring process environment 100 in optional combination with one or more weather data systems 130. The process environment 100 includes input of field data 110, and one or more client devices 140. The process environment 100 also includes a central command 120 that allows for communication between various components of the process environment 100.

During operation, field data may be uploaded into the system both manually or automatically. Field deployment can include manual deployment of personnel to document event characteristics, or field data collection through remote techniques, including aerial photographs, use of cartographic cameras, and/or satellite images. The field data 110 collected may be uploaded into the system either automatically or manually through an appropriate user interface. The user driven field data entry could be done in one of many embodiments, including a menu and icon driven approach to enable field personnel to provide reports on incidents and disaster, including classifying the type and scale of disaster, assessing victims and/or casualties, estimating the extent and type of physical damage, uploading photos, videos, audio, text, and other documents, and making recommendations to prioritize the response. In some implementations, the menu and icon driven approach may also be enhanced to provide menus and icons of a generic nature, and also those customized for a particular type of disaster. In some other implementations, the menus and icons may be presented in an interactive manner wherein a particular input into a field data value prompts a further enquiry from the system. In some implementations, the field personnel may be allowed to create data entry fields to enter specific kinds of data. In all such intelligent implementations, the systems may generate a field for data entry based on a learning model from previous field reports. Various implementations of data entry methods could include mobile applications on mobile devices.

Disaster related information may also be received through one or more weather data systems 130. In some implementations, the feeds may be received from social media platforms, television stations, or feedback from clients, vendors, personnel, or other individuals on the ground that may be monitoring the weather. These may include feeds pertaining to meteorological data indicative of a weather phenomenon. In particular, the weather data system 130 could be received from a source such as NEXRAD weather data provided by the National Weather Service. Such data may also be received directly from a real-time weather source such as a Doppler or pulse-Doppler weather data system managed by a television or cable network. Such data may also be received from a single or multiple weather data provider vendors. Many weather display systems are configured to communicate and message real-time with a communication and monitoring process environment 100 as disclosed herein.

The central command 120 includes memory for storage of data and software applications, a processor for accessing data and executing applications, and components that facilitate communication over the network in the process environment 100. When weather data from a weather data system 130 is provided to the central command 120, it may map the data onto a weather map and identify a potential geographic area that has been affected. Some weather data systems 130 may already be an initial attribute in the form of a map. In some implementations, once a potential geographic area is identified, the central command 120 may send out signals to field agents and remote sensing devices near the affected area to alert them to the possibility of identifying and uploading field data. In some other implementations, the central command 120 may send signals to field agents and remote sensing devices near the affected area requesting specific data. Such a request may be based on past responses to a disaster of a similar nature. Such communication may take place over one or more mobile devices.

The field data 110 and the data from one or more weather data systems are then processed. The initial attributes are modified to generate one or more augmented attributes. In some implementations, the representation of the one or more augmented attributes may include representation on a display device. In some implementations, this representation may be in the form of a real-time mapping of the affected area. In some implementations, such a map may be an interactive display with icons and menus that are capable of providing further data, and/or provide access to location specific images, audio, video, and related documents. Once a visual display is ready, it is provided to a variety of clients on a client device 140. Field or client output devices may include a display, a printer, a fax machine, or non-visual displays such as audio output devices, or mobile devices. The displays may include a cathode ray tube (CRT), a flat-panel device such as a liquid crystal display (LCD), a projection device, or some mechanism for creating a visible image. The representation may also provide non-visual display such as via audio output devices. One or more augmented attributes from the database may be sent to vendors such as weather systems, mapping services, television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written or audio description of the affected geographic area. These maps may be available to end-users in either electronic form, for example by way of email, specialized web pages, or mobile applications, or by written or typed document. Clients and a variety of end users interact with the central command 120 through the client computing devices 140. The client computing devices 140 include memory for storage of data and software applications, a processor for accessing data and executing applications, and components that facilitate communication over the network in the process environment 100. The computing devices 140 execute applications, such as web browsers 150, that allow clients to interact with the visual displays and other information provided by the central command 120.

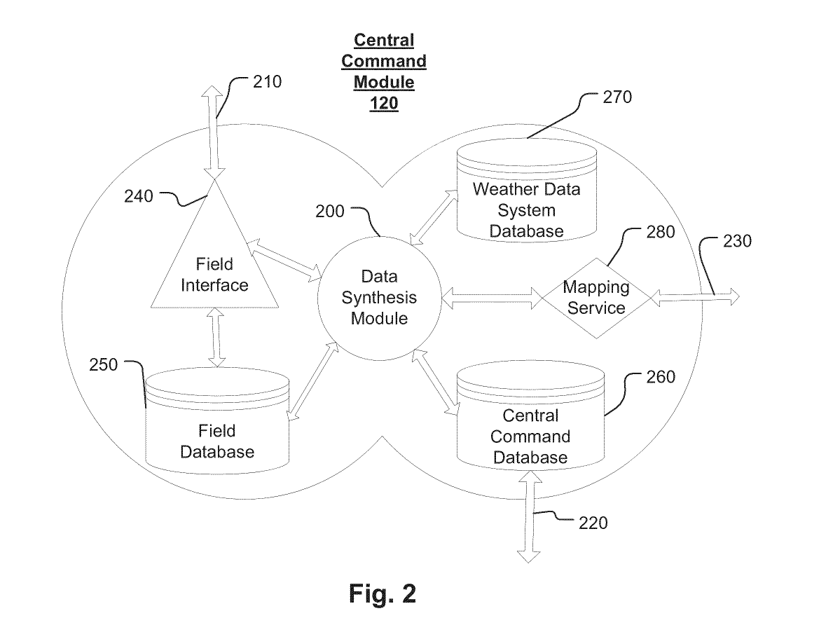

FIG. 2 illustrates a block diagram of an example central command module 120. The unidirectional and bidirectional arrows are merely representative of this particular example. Different directions may be used in different implementations. The central command module 120 comprises a data synthesis module 200 that may operate as a nerve center of all operations. The central command 120 may have one or more external communication networks. In this example, field network 210 communicates with remote sensing devices and devices operated by field personnel to input field data 110. Disaster management network 220 communicates with one or more weather data systems 130 to receive real-time data related to the disaster. Client service network 230 communicates with one or more client devices 140.

The weather data system database 270 is configured to receive and process initial attributes, including weather data received from one or more sources. This data may be directly or indirectly transferred, processed, and stored in the central command database 260. The field database 250 is configured to receive and process field data received from one or more field input sources. This data may be directly or indirectly transferred, processed, and stored in the central command database 260. The central command database maintains data on present and past disasters and the responses to those disasters. The weather data system database 270, the field database 250, and the central command database 260 are all in communication with the data synthesis module 200. The data synthesis module 200 receives processes and synthesizes the data from all three databases and creates one or more representations of the data. The particular representation depends on the type of client and the degree of detail that is required by the particular client. In some implementations, the data representation may take the form of an interactive map which is created and updated by the mapping service 280. The mapping service 280 is in communication with the data synthesis module 200. As real-time data pours in from the field and the weather stations, this data is synthesized by the data synthesis module 200, stored in the central command database 260 and relayed to mapping service 280 to update the interactive visual displays.

The field data may comprise data from field personnel deployed in the target geographic area or data captured through one or more social media platforms. The at least one source providing the field data may be a field personnel. Communication may include communication using a mobile device. In some implementations, the data synthesis module 200 may prompt the field interface 240 to send signals to field agents and remote sensing devices near the affected area requesting specific data. In some implementations, the central command module 120 may receive queries from the client devices 140 over the network 230, and execute the queries against the central command database 260 against the available documents such as web pages, images, text documents and multimedia content. The data synthesis module 200 identifies content that matches the queries, and responds by signaling the mapping service 280 to generate interactive displays, tags, menus, icons, and other means that are then transmitted to the client devices 140 in a form that can be presented to the clients.

The central command database 260 may include log files of data regarding client queries, documents viewed, weather data, past responses to weather, field data inputs, data field created by field personnel, etc. The log files may further include time stamp data and session id data that facilitate grouping of documents and other multimedia data.

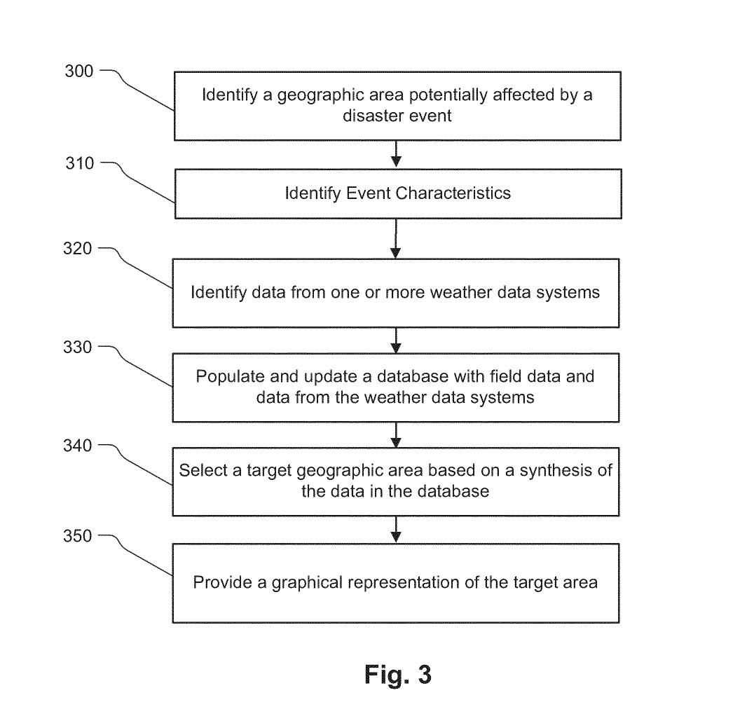

FIG. 3 illustrates a flow diagram of an example process that includes a feed from a weather data system. For convenience, the method 300-350 will be described with respect to a system that performs at least parts of the method. At step 300, the central command module 120 may receive data from one or more weather data systems 130 or other independent sources that indicate an imminent or recent disaster. A disaster event may include a weather related event (thunderstorm, tornado, snowstorm, hailstorm, lightning, drought, fires), a natural disaster event (earthquake, tsunami, floods, volcanoes), and/or a human induced event (wars, fires). The data synthesis module 200 identifies a potential geographic area that may be affected by the disaster event.

At step 310, the process identifies a set of event characteristics. These characteristics may be identified based on data from the weather data system 130 or from prior saved data stored in the central command database 270. These characteristics may also be identified based on field deployment. Field deployment can include manual deployment of personnel to document event characteristics, or field data collection through remote techniques, including aerial photographs, use of cartographic cameras, and/or satellite images.

The event characteristics pertaining to a disaster event generally depend on the disaster itself. These are characteristics pertaining to the prevalent weather conditions, and specific conditions related to the type of physical damage. Event characteristics may include photographs of the damage, sampling of field data pertaining to the size, spread and magnitude of impact characteristics, geo-position markers for event impact areas, real-time reading of humidity, pressure, temperature, wind velocity, water level, etc. For instance, flooding can often be the cause of basement wall, foundation and retaining wall failure. Special techniques using various camera technologies like infrared thermography may be used to accurately collect pertinent field data that may then enable damage assessment.

Most parts of the United States are susceptible to hail, and there is an average of 3,000 hailstorms a year. During a hailstorm, event characteristics would include descriptors that include the size of hail, the duration of a hailstorm, and wind direction, and these descriptors may then be correlated to the type and extent of damage to a roof based on logs of past disaster response and recovery efforts. This assessment may additionally factor in the type of roofing and the kind of shingle used. Similarly, hail damage to an HVAC unit may be assessed by certified forensic technicians who evaluate the unit on-site, upload the field data, and provide additional texturing to the map.

During ice storms, physical damage may be caused by fire from downed power lines, or damage to physical property from fallen trees or tree limbs, or acute damage as a result of ice damming. Heavy rain from tropical storms or a thunderstorm may cause problems around a home or commercial structure. Rain-related problems include water leaking into the framing of the roof and soil saturation. Roof systems may be damaged by snow, when excessive snow accumulates on the roofing structure. Steel-framed structures may also be damaged by excessive snowing that causes loads to exceed the expected loading.

Lightning causes estimated losses of over $5 billion per year within the United States alone. Predetermined event characteristics may be used by forensic engineers to determine whether the reported damage is due to lightning or not, and also to determine the geographic area likely to have been impacted by a lightning strike. In each such instance, different event characteristics tailored to the specific type of disaster event would need to be collected and uploaded into the database.

At step 320, the process identifies data from one or more weather data systems 130. These may include feeds pertaining to meteorological data indicative of a weather phenomenon. In particular, the weather data system 130 could be received from a source such as NEXRAD weather data provided by the National Weather Service. Such data may also be received directly from a real-time weather source such as a Doppler or pulse-Doppler weather data system managed by a television or cable network. Many weather display systems are configured to communicate and message real-time with a communication and monitoring process environment 100 as disclosed herein.

At step 330, the data synthesis module 200, in conjunction with the central command database 260, the field database 250 and the weather data system database 270, populates and updates a database with field data 110 and data from the weather data system 130. In some implementations, an interim graphical or visual representation of this data is formed by the mapping service 280. This interim representation of data may be conveyed to one or more client devices 140 as a real-time, dynamic and interactive map. In some implementations, the data synthesis module 200 maintains bidirectional communication networks comprising the field network 210 which communicates with remote sensing devices and devices operated by field personnel to input field data 110; the disaster management network 220 which communicates with one or more weather data systems 130 to receive real-time data related to the disaster; and the client service network 230 which communicates with one or more client devices 140. These communication networks may be completely or partially manual or automated. These networks communicate with the field devices, client devices and disaster management fields to further enhance the quality and understanding of the data received, thereby updating the real-time, dynamic and interactive map.

At step 340, the communication and monitoring process environment 100 synthesizes the data received and forms the map of a target geographic area. This step is of particular use in certain industries, for example, the insurance industry. Storms cause physical damage to various properties. In order to efficiently validate and process property damage claims, insurance companies, state and federal agencies, and/or other organizations, need to verify both the geographical boundary of the affected area, and the type and extent of damage to individual properties within the area. The volume of post event claims is typically high. This makes it near impossible for insurance companies to send field agents to verify each claim. An embodiment of the present invention is directed at providing dependable, verifiable, and accurate real-time field data that has been correlated to real-time data feed from a weather data system and synthesized to create a true mapping of the area affected by the disaster and the extent and type of damage that has been inflicted upon that area. In some implementations, the representation of the one or more augmented attributes may include representation on a display device. In some implementations, this representation may be in the form of a real-time mapping of the affected area. In some implementations, such a map may be an interactive display with icons and menus that are capable of providing further data, and/or provide access to location specific images, audio, video, and related documents. The representation may also provide non-visual display such as via audio output devices. One or more augmented attributes from the database may be sent to vendors such as weather systems, mapping services, or television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written or audio description of the affected geographic area. These maps may be available to end-users in either electronic form, for example by way of email, specialized web pages, or mobile applications, or by written or typed document. As is well known in the art, a typed document may include a computer printed report and/or an electronic report (e.g., in portable document format).

For instance, an augmented map that represents the target geographic area affected by the disaster related event may be prepared. An initial map of a target area morphs into an augmented map representing the scope and dimension of the disaster. The details in the augmented map may be further enhanced to provide collateral indicators to determine if a claim was a result of a disaster event or another cause. The insurance company uses this data to validate insurance claims, and saves its time and resources to individually pursue claims that fall outside the reported damage area, or fall at or close to the boundary of the reported damage area. This substantially reduces the strains on the insurer's financial and human resources, while also ensuring a fast, reliable and efficient mechanism for the insured individual to have their legitimate claims authorized by the insurance company.

Field input sources that communicate over communication network 210 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into central command module 120.

At step 350, the central command module 120 produces some user friendly representation of the disaster related data. In some implementations, a mapping service 280 within the central command module 120 may create specialized maps that may be interactive, offering different levels of detail, 2-D, 3-D or satellite views, populated with positional icons with field data, and/or contour mapping. Additionally, the maps may be drawings or simply a written or audio description of the affected geographic area. These maps may be available to end-users in either electronic form, for example by way of email, specialized web pages, or mobile applications, or by written or typed document.

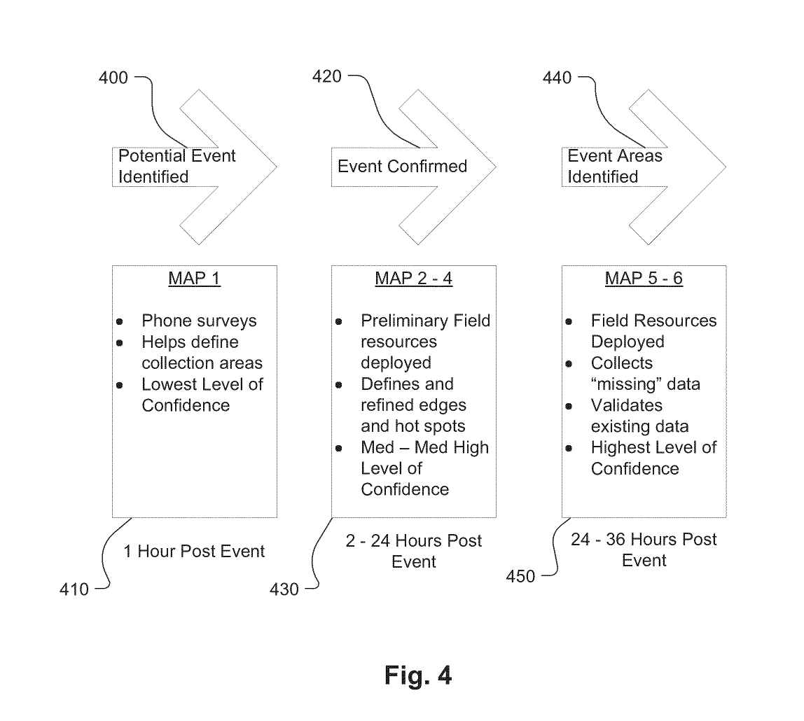

FIG. 4 illustrates a block diagram of an example post event periodic retrieval and update process of the disclosed system and method. In many instances, after a particular disaster event occurs, the landscape of damage and recovery may not be immediately ascertainable. This may be due to a variety of reasons, including the lack of physical access to the affected area. In such situations, the process environment 100 acts iteratively by taking snapshots of available data at pre-determined post-event time intervals. The data synthesis module 200, in conjunction with the central command database 270, the field database 250 and the weather data system database 260, populates and updates a database with field data 110 and data from the weather data system 130 at these predetermined time intervals. In some implementations, an interim graphical or visual representation of this data is formed by the mapping service 280.

In one implementation, at step 400, an hour after a potential disaster related event, the process environment 100 identifies the event. A first interactive map 410 is created based on initial field surveys. This first interactive map 410 may be considered to have the lowest level of confidence, but it helps define the geographical areas in which further detailed information is needed.

At step 420, during a time interval of 2 to 24 hours after the reported event, the event is confirmed. The next few iterations of the interactive map are formed; for instance iterations 2 through 4 are shown at step 430. These maps show the field data collected which defines and refines the edges and hot spots of the affected area. These iterations may be considered to have some more real-time data and are considered to have medium to medium high level of confidence.

Finally, at step 440, during a time interval of 24 to 36 hours after the reported event, sufficient data is collected and synthesized to form a final boundary of the event area. At step 450, the final interactive map shows the field resources, identifies any missing field data that may need to be collected, and validates existing data against feeds from the weather data systems and the field data. This iteration of the interactive map is considered to have the highest level of confidence.

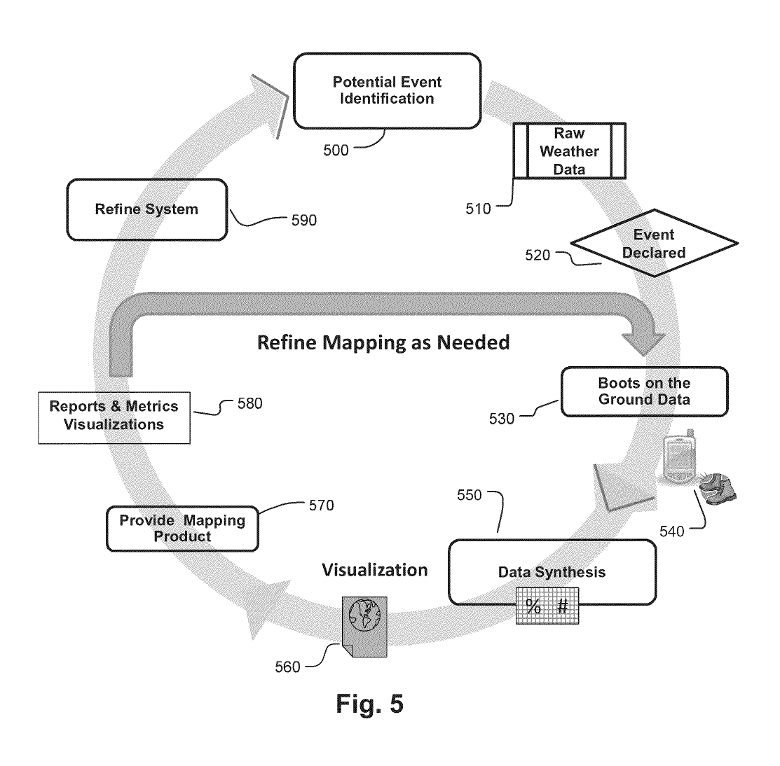

FIG. 5 illustrates a block diagram of an example communication and monitoring process environment. At step 500, a potential event is identified. At step 510, raw weather data is received. For instance, the central command module 120 may receive raw weather data from one or more weather data systems 130 or other independent sources that indicate an imminent or recent disaster. These may include feeds pertaining to meteorological data indicative of a weather phenomenon. In particular, the weather data system 130 could be received from a source such as NEXRAD weather data provided by the National Weather Service. Such data may also be received directly from a real-time weather source such as a Doppler or pulse-Doppler weather data system managed by a television or cable network. Many weather display systems are configured to communicate and message real-time with a communication and monitoring process environment 100 as disclosed herein. A disaster event may include a weather related event (thunderstorm, tornado, snowstorm, hailstorm, lightning, drought, fires), a natural disaster event (earthquake, tsunami, floods, volcanoes), and/or a human induced event (wars, fires). The data synthesis module 200 identifies a potential geographic area that may be affected by the disaster event and at step 520 an event is declared to have occurred.

At step 530, event characteristics may be identified based on data from the weather data system 130 or from prior saved data stored in the central command database 270. These characteristics may also be identified based on field deployment. Field deployment can include manual deployment of personnel to document event characteristics, or field data collection through remote techniques, including aerial photographs, use of cartographic cameras, and/or satellite images. Field input sources 540 that communicate over communication network 210 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into central command module 120.

At step 550 the data synthesis module 200, in conjunction with the central command database 270, the field database 250 and the weather data system database 260, populates and updates a database with field data 110 and data from the weather data system 130. The field data may comprise data from field personnel deployed in the target geographic area or data captured through one or more social media platforms. The at least one source providing the field data may be a field personnel. Communication may include communication using a mobile device. In some implementations, the database may be updated with field data including automated receipt and update of data, including data from field deployed remote sensors, cartographic cameras, aerial reconnaissance systems, or satellite images. In yet other implementations, the updating of the database with the field data may include iterative updating of the database at pre-determined time intervals.

In some implementations, an interim augmentation such as a preliminary graphical or visual representation 560 of this data may be formed. This interim representation of data may be conveyed to one or more client devices as a real-time, dynamic and interactive map. In some implementations, the data synthesis module maintains bidirectional communication networks comprising the field network which communicates with remote sensing devices and devices operated by field personnel to input field data; the disaster management network which communicates with one or more weather data systems to receive real-time data related to the disaster; and the client service network which communicates with one or more client devices. These communication networks may be completely or partially manual or automated. These networks communicate with the field devices, client devices and disaster management fields to further enhance the quality and understanding of the data received, thereby updating the real-time, dynamic and interactive map. Communication may include communication using a mobile device and/or be conducted over cloud servers.

At step 570, the communication and monitoring process environment 100 synthesizes the data received and transforms the initial attributes received into one or more augmented attributes. In some implementations, the environment 100 may form the map of a target geographic area to provide a mapping product such as an augmented map. The map itself may be tagged, annotated and/or accompanied by menus, icons, photographs, text, and audio, related to the disaster event. At step 580 reports and metric visualizations are created that may require further input from field devices 540. Steps 530-580 may be repeated iteratively to refine the mapping product 570. At step 590, the system that controls the process environment may also be refined through the iterative process.

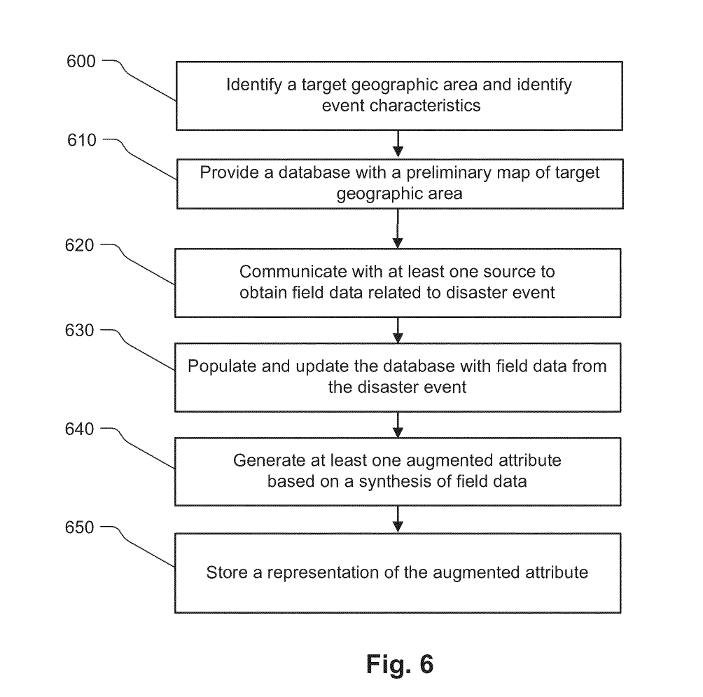

FIG. 6 illustrates a flow diagram of an example process that may not include a feed from a weather data system. For convenience, the method 600-650 will be described with respect to a system that performs at least parts of the method, and this example will be further described in relation to the disaster event being a hailstorm. At step 600, the system described herein may receive data from one or more sources that indicate an imminent or recent disaster. Such sources may include feeds from weather systems, or cable and/or television networks, or may include preliminary reports from field agents, individuals, and/or first response teams in the affected area. A potential geographic area that may be affected by the disaster event is identified and a set of event characteristics pertaining to the particular event are also identified.

For instance, when the disaster event is a hailstorm, initial reports may be received from individuals in the affected area, or from a television report, or a Doppler or pulse-Doppler weather system. A target geographic area is then determined. Typical event characteristics may include descriptors that include the size of hail, damage to property, the duration of a hailstorm, and wind direction. These descriptors may already be in the system database and may be presented to field personnel in on or more preset data entry fields.

At step 610, the system creates a preliminary map of the targeted geographic area. This may include some initial data regarding the type, degree and scope of the disaster event. In some implementations, this step may also include obtaining initial data from one or more independent clients, individuals and/or vendors that verifies that a disaster event has indeed occurred. Such verification may involve a phone verification system by an independent vendor wherein telephone calls are made to residents in the target area to map out an initial target area. The preliminary map may also be obtained using a satellite image of the targeted area.

At step 620, the system communicates with at least one source to obtain field data related to the disaster event. This field data may include responses to system prompts regarding predetermined event characteristics. This step may also involve data entry into new or existing data fields by field personnel. The data itself may be in the form of interviews, photographs, text, and other descriptors pertaining to the disaster event. In the case of a hailstorm, the field data may record the different sizes of the hail in different parts of the target geographic area, the duration of the hailstorm, a time-dependent vector field describing the wind velocities, or the types of damage within the geographic area. For example, in certain parts within the geographic area, the resultant damage could be to the roof systems, and in certain other parts, the resultant damage could be to HVAC systems. In yet other parts, the damage could be to the walls of the residential or commercial property. Additionally, the degree and extent of damage inflicted in different parts of the targeted geographic area may vary depending on the size of the hail, the duration of the hailstorm, and the wind velocity. Field data collected will be customized to account for these varying factors.

At step 630, the database is populated and updated with the field data. This process may be at least partially automated. As the data comes in, the system may prompt one or more field personnel for more data, or remotely configure remote sensing devices to gather more localized data. In some implementations, an interim or preliminary graphical or visual representation of this data may be implemented by a mapping service. This interim representation of data may be conveyed to one or more client devices as a real-time, dynamic and interactive map.

At step 640, the system generates at least one augmented attribute of the target area based on a synthesis of the field data in the database. In some implementations, the system synthesizes the data received and forms the map of a target geographic area. In some implementations, the system maintains bidirectional communication networks comprising the field network which communicates with remote sensing devices and devices operated by field personnel to input field data and the client service network which communicates with one or more client devices. These communication networks may be completely or partially manual or automated. These networks communicate with the one or more field devices and client devices to further enhance the quality and understanding of the data received, thereby refining the real-time, dynamic and interactive map. The field data is further used to authenticate or dismiss the initial data and reports received. As more verifiable field data is fed into the system, a clearer picture of the damage begins to emerge.

For instance, in the event of a hailstorm, data related to the size of the hailstorm is initially received and an initial attribute, such as a contour map of the target region may be formed based upon the sizes of the hail reported. These initial reports are then verified by actual measurements by field personnel. The field data may also include photographs of the damage caused by the hail. As more data is received, an augmented map is formed, which may, in one implementation, be a contour map that describes the target geographic region in terms of hail size. A given contour represents parts of the region that were impacted by hail of a given size. This contour map may then be overlaid by data representing vectors of wind velocity. The extent of damage to a roof may be estimated from these factors based on predetermined conditions correlating the damage to the event characteristics. In some implementations, the system may be programmed to make such predictive analysis. A mapping service may then augment the map of the geographic region depending upon the likelihood of damage, its type and extent.

At step 650, the system stores a representation of the at least one augmented attribute. In some implementations, an augmented map may be stored and may be optionally delivered onto a client device. Such a device may include mobile devices, desktop devices, or a combination of both. The details in the augmented map provide collateral indicators to determine if a claim was a result of a disaster event or another cause. For instance, in some implementations, the augmented map may be subdivided into grids, wherein each individual grid may be considered to be within the affected area, outside the affected area, or fall within an ambiguous region where individual properties would need to be further analyzed to obtain an accurate picture. The insurance company uses this data to validate insurance claims for properties that fall within the affected area, and dismiss claims that fall outside the affected area. It may choose to individually pursue claims from properties that are in the ambiguous region of the target area. This substantially reduces the strains on the insurer's financial and human resources, while also ensuring a fast, reliable and efficient mechanism for the insured individual to have their legitimate claims authorized by the insurance company.

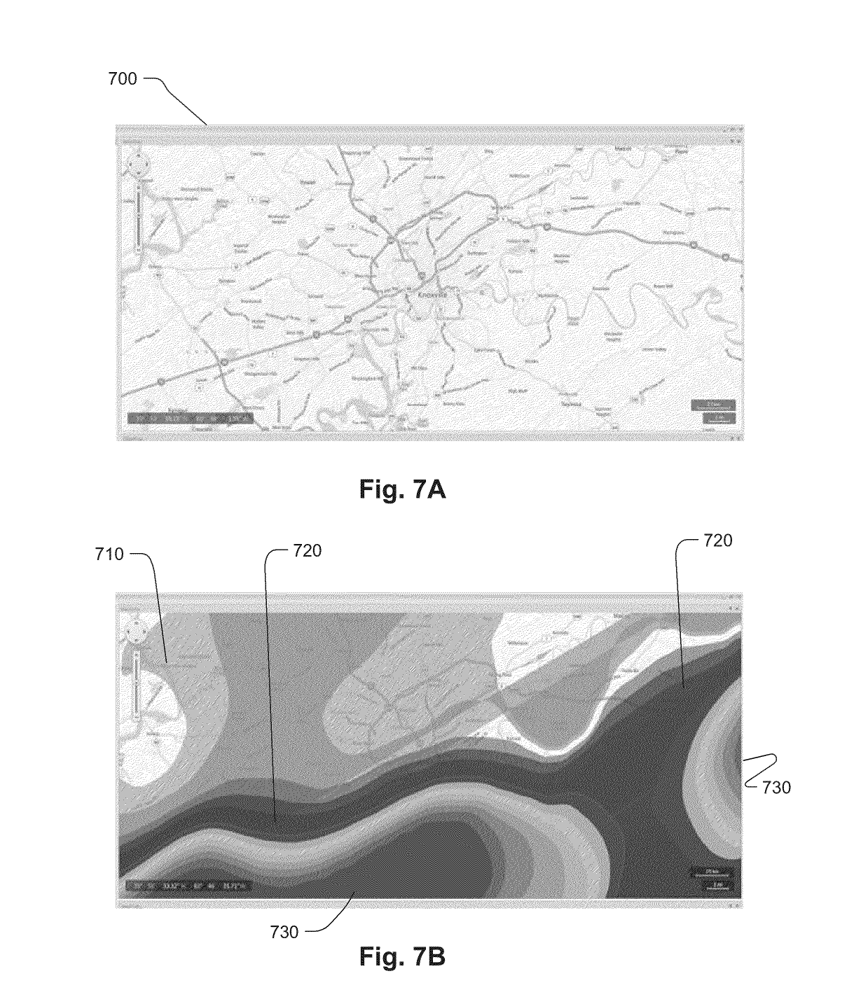

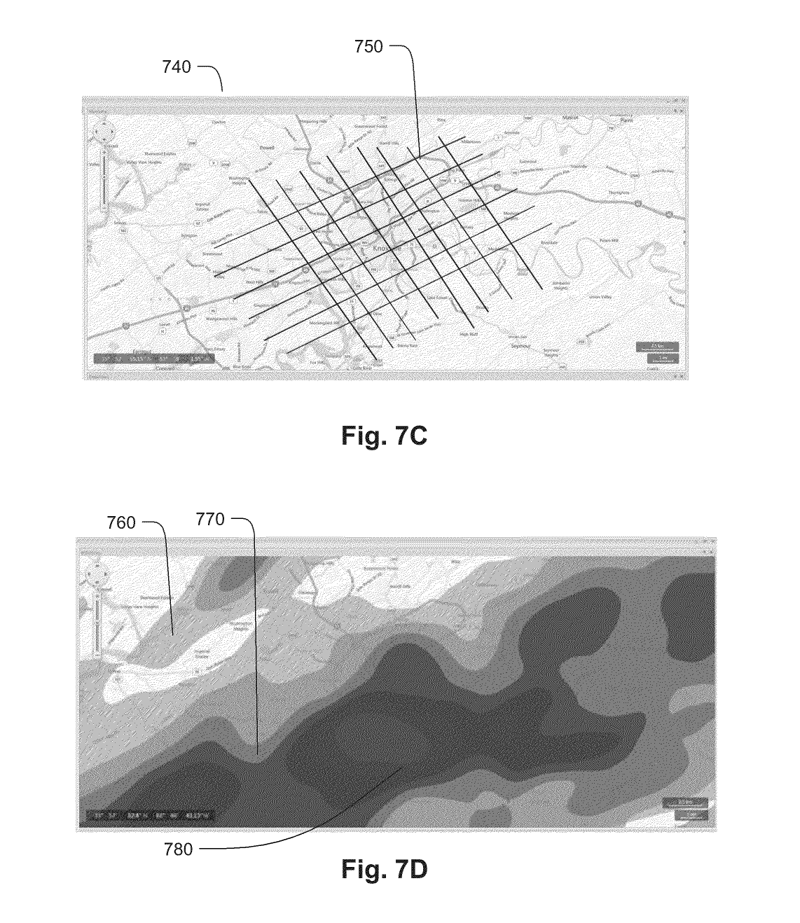

In general, one aspect of the technology described can be embodied in methods that include identifying a target geographic area potentially affected by a disaster event, and identifying event characteristics. The method further includes providing a database with at least one initial attribute of the target area. The method further includes communicating with at least one source to obtain field data related to the disaster event, and updating the database with the field data. The method further includes generating at least one augmented attribute of the target area based on a synthesis of the field data in the database. A representation of the at least one augmented attribute is then stored. FIGS. 7A-D illustrate one implementation of the method.

The disaster event may be a weather-related event comprising a thunderstorm, tornado, snowstorm, hailstorm, lightning, drought, or fire. FIG. 7A illustrates an example map based on a feed from a weather data system indicating a hailstorm in a geographic area. A large geographic region 700 is identified based on information received from a weather data system such as a feed from a disaster management system, a television signal, a Doppler or pulse-Doppler radar signal, or feeds from one or more social media platforms such as facebook, twitter, etc. The feeds indicate a large hailstorm that encompasses a large area.

FIG. 7B illustrates an example of an initial attribute in the form of a contoured map representing projected hailstone sizes. Predicted hailstone sizes are identified on a contoured map. The region 710 corresponds to the smallest sized hail stone; region 720 corresponds to intermediate sized hail stone, whereas the regions 730 correspond to the largest sized hail stone. The entire identified geographic region 700 is thus initially attributed with initial data from a weather feed.

FIG. 7C illustrates an example of a map representing a data collection grid to capture event characteristics. Event characteristics may comprise factors such as the average size of the hail, the affected geographical area, the time length of the storm, the typical size of hail impact, the damage to property, or the wind velocities. A strategy is developed to collect event characteristics from the field. A preliminary map 740 indicates a data collection grid 750 that divides a portion of the geographic area and identifies it as the region from where field data will be collected. The preliminary map and the data collection grid are further examples of an initial attribute.

The field data may comprise data from field personnel deployed in the target geographic area or data captured through one or more social media platforms. The at least one source providing the field data may be a field personnel. Communication may include communication using a mobile device. In some implementations, the database may be updated with field data including automated receipt and update of data, including data from field deployed remote sensors, cartographic cameras, aerial reconnaissance systems, or satellite images. In yet other implementations, the updating of the database with the field data may include iterative updating of the database at pre-determined time intervals.

FIG. 7D illustrates an example of an augmented attribute. In this example, it is a contoured map representing actual hailstone sizes based on field data. In the figure, region 760 corresponds to the smallest sized hail stones, region 770 corresponds to intermediate sized hail stones, whereas region 780 corresponds to the largest sized hail stones. A comparison of the initial attribute in FIG. 7B and the augmented attribute in FIG. 7D clearly indicates how the field data informs and modifies the initial data obtained from the weather feeds. For instance, a region 730 projected to receive large hail stones actually received intermediate sized hailstones. Similarly, region 730, projected to receive large hailstones, morphs into a considerably smaller region 780.

In some implementations, the representation of the augmented attribute may be a visual representation, and in some implementations, the visual representation may include a map of the target geographic area. In some implementations, the at least one initial attribute may include an initial map of the target geographic area. The visual representation may include an augmented map of the target geographic area based on the event characteristics. In some implementations, the at least one target geographic area may be obtained from a weather data system. In some implementations, the at least one target geographic area may be obtained from a social media platform.

In some implementations, the representation of the one or more augmented attributes may include representation on a display device. Field or client output devices may include a display, a printer, a fax machine, or non-visual displays such as audio output devices, or mobile devices. The displays may include a cathode ray tube (CRT), a flat-panel device such as a liquid crystal display (LCD), a projection device, or some mechanism for creating a visible image. The display may also provide non-visual display such as via audio output devices. One or more augmented attributes from the database may be sent to vendors such as weather systems, mapping services, or television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written or audio description of the affected geographic area. These maps may be available to end-users in either electronic form, for example by way of email, specialized web pages, or mobile applications, or by written or typed document. In general, use of the term “output device” is intended to include all possible types of devices and ways to output information from central command module 120 to the field personnel, client or to another machine or computer system.

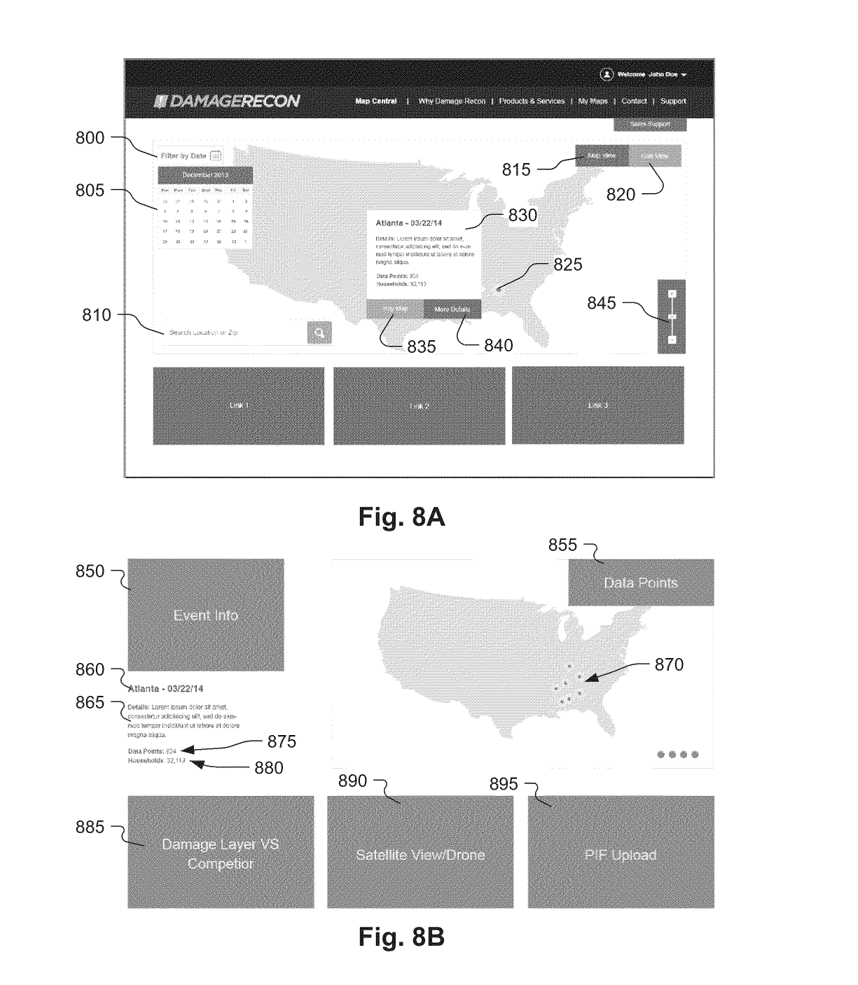

FIG. 8A illustrates an example of an interactive map of a target geographic area. An option 800 to select a time period is shown. In some implementations such an option 800 may include a calendar 805 (e.g., a pop-up calendar) that may be utilized to select a date and/or a start and end date. A search field 810 may be provided to enter a query, such as a geographic area in the form of one or more of an address, zip code, county, city, state, street, insurance provider, property value, and property type. The user may search for a target geographic area based on the entry in the search field 810. For example, the user may enter “Atlanta” in the search field 810 and a report 830 may be displayed for Atlanta 825. The report 830 may include the name of the target geographic area, the date, the available field data, and data related to one or more objects in the target geographic area. For example, the report 830 may include the city, Atlanta 825, indicate some event characteristics related to Atlanta 825, indicate that there are 304 available field data points from Atlanta, and that there are 32,113 households in or near Atlanta that may be potentially affected. In some implementations the number of available field data points may indicate the number of locations from where field data may be available. For example, field data may be collected via phone surveys of residents in the target geographic area. Such phone surveys may elicit information related to the at least one event characteristics. In some implementations, such surveys may be statistically analyzed to reduce sampling error, and/or to increase confidence levels. As described herein with reference to FIG. 4, first interactive map may be provided based on initial field surveys. For example, at step 400, in some implementations the potential event may be identified 8-24 hours after the event ceases, phone surveys may be conducted, and a first interactive map may be provided. A confidence level may be associated with the first interactive map based on the number of phone surveys and the quality of the responses (e.g., do the responses corroborate each other). The time of identification of the event may be determined on one or more factors, including the type of event, the target geographic area, and so forth. Also, with reference to FIG. 4, at step 420, during a time interval of 8 to 24 hours after the reported event, the event may be confirmed.

In some implementations the report 830 may include a selectable option to purchase 835, and/or provide an option for more details 840. The interactive map may include an option for map view 815 and/or an option for grid view 820. The map view 815 may provide an interactive map of the target geographic area. The grid view 820 may provide an interactive map of the target geographic area based on an interactive grid. In some implementations the grid may include the geographic area from which field data is available. In some implementations the grid may comprise all addresses in the geographic area, and the attributes may be assigned to each grid. The interactive map may include conventional features such as a zoom option 845, an ability to select a portion of the interactive map by tracing a boundary of the desired region (e.g., with a mouse, with a finger in a touch sensitive screen), an ability to click at a point on the interactive map to display additional information related to the point, and so forth.

FIG. 8B illustrates another example of an interactive map, including a selectable option associated with at least one attribute. The interactive map may include a selectable option associated with an event 850, a selectable option associated with field data points 855, a selectable option associated with a comparison of the at least one radar characteristic with the at least one event characteristic 855, a selectable option associated with satellite and/or drone view 890, a selectable option to upload one or more of geocoded data and data based on insurance policies-in-force (“PIF”) 895. The interactive map may be the map of the United States showing a target geographic region 870. In some implementations a report based on the target geographic region may be provided to the user. For example, the user may enter “Atlanta”. The report may include the name of the target geographic area, the available field data, and data related to one or more objects in the target geographic area. For example, the report may include the city and date 860 (e.g., Atlanta—03/22/14), indicate some event characteristics 865 related to Atlanta, indicate the number of available field data points 875 from Atlanta (e.g., 304), and the number of households 880 in or near Atlanta that may be potentially affected (e.g., there are 32,113). Based at least in part on such a report, a user, such as an insurance company, may be better equipped to make decisions related to insurance claims. In some implementations the report may be provided with an option to purchase the interactive map with the at least one attribute.

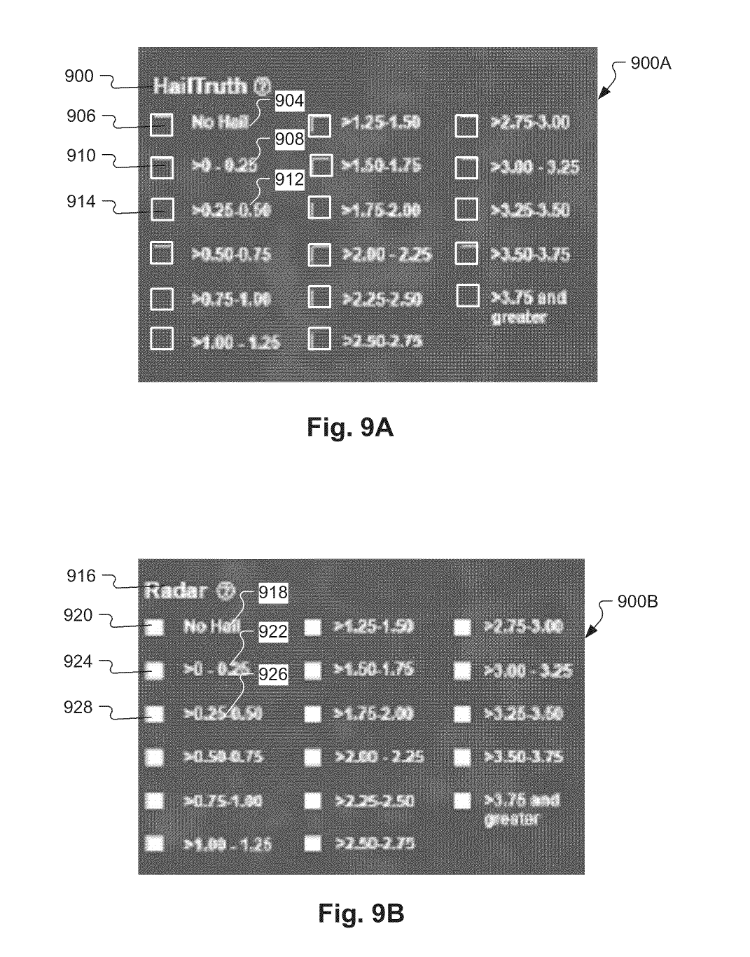

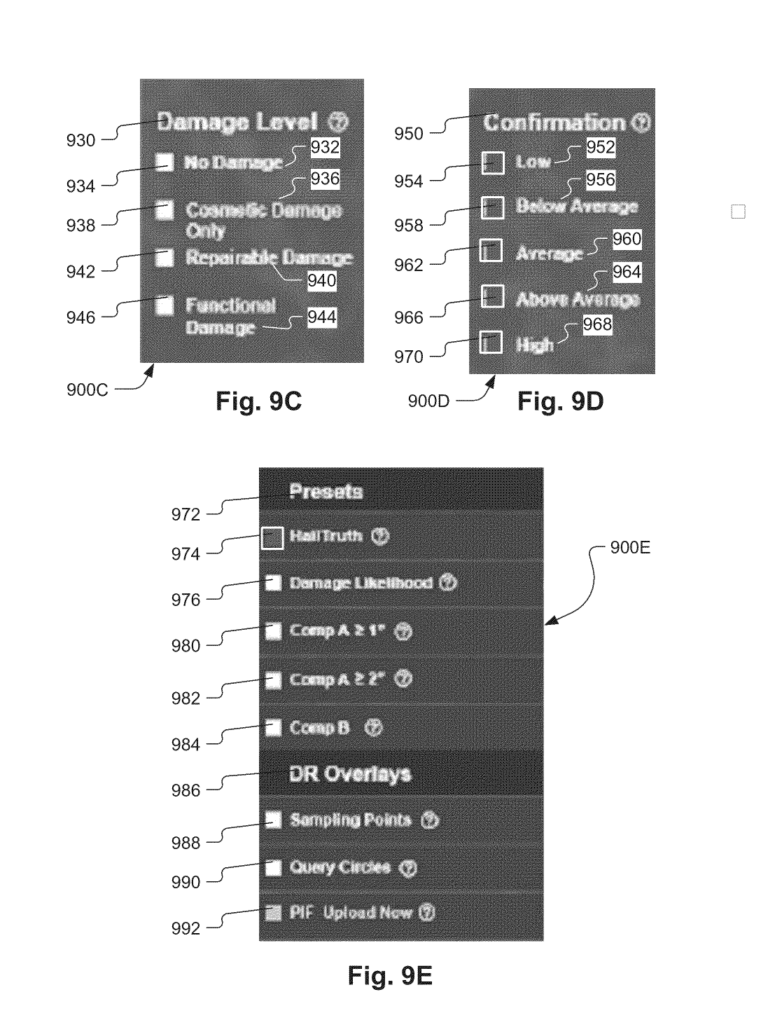

FIG. 9A illustrates an example of a selectable option associated with the at least one event characteristic. As described herein, the at least one event characteristic may relate to an event. The event may be a weather related event (e.g., thunderstorm, tornado, snowstorm, hailstorm, lightning, drought, wind, fire), a natural event (e.g., earthquake, tsunami, floods, volcanoes, avalanches), and/or a human induced event (e.g., wars, fires, train derailments, spills, releases, automobile crashes, airplane crashes, stampede, and so forth). Also, for example, the event may be a hurricane, a land movement (e.g., landslide, sinkhole, and erosion), fire, smoke, and ash. In some implementations the event may be a hail storm, and the at least one event characteristic may be a distribution of actual hail sizes in the target geographic area. In this figure, the at least one event characteristic 900A illustrated is the actual hail size, Hail Truth 900, resulting from a hailstorm. The field data, for example the actual hail size, may be received from one or more sources, including data from field personnel deployed in the target geographic area. Also, for example, phone surveys may be conducted in the target geographic area, and information pertaining to actual hail size (e.g., ranges of hail sizes), duration of the hail event, observed damage, and so forth may be collected. In some implementations the at least one event characteristic may be associated with a plurality of selectable options. In some implementations, such options may be toggled on or off, indicating inclusion or non-inclusion of the corresponding option. For example, a first selectable option 906 may be provided for the at least one event characteristic of “No Hail” 904. When the first selectable option 906 is clicked or toggled on, as shown here, the interactive map may be shown with the areas that did not receive any hail. As another example, a second selectable option 910 may be provided for the at least one event characteristic representing hail size “greater than zero and less than 0.25 inches” 908. When the second selectable option 908 is clicked or toggled on, as shown here, the interactive map may be shown with the areas that received hail, but the hail sizes were less than 0.25 inches. When the first selectable option 906 and the second selectable option 910 are simultaneously toggled on, then the interactive map may be shown with the areas that did not receive hail, and the areas that received hail, but the hail sizes were less than 0.25 inches. Also, for example, a third selectable option 914 may be provided for the at least one event characteristic representing hail size “greater than 0.25 inches and less than 0.50 inches” 912. When the third selectable option 914 is clicked or toggled on, as shown here, the interactive map may be shown with the areas that received hail, with hail sizes greater than 0.25 inches and less than 0.50 inches. Several more selectable options are illustrated for different hail sizes.

FIG. 9B illustrates an example of a selectable option associated with the at least one radar characteristic. In many instances, the at least one radar characteristic may be based on projected data, for example, data based on any form of weather radar, including Doppler radar. For example, in some implementations the at least one radar characteristic may be based on one or more of Doppler radar data, pulse-Doppler radar data, data from a provider of weather-related services, data from a provider of disaster-related services, shape files from a vendor. In some implementations the event may be a hail storm, and the at least one radar characteristic may be a distribution of projected hail sizes, based on Doppler radar data, in the target geographic area. In this figure, the at least one radar characteristic 900B illustrated is the projected size of hail, Radar 916, resulting from the Doppler radar data.

In some implementations the at least one radar characteristic may be associated with a plurality of selectable options. In some implementations, such options may be toggled on or off, indicating inclusion or non-inclusion of the corresponding option. For example, a fourth selectable option 920 may be provided for the at least one radar characteristic of “No Hail” 918. When the fourth selectable option 920 is clicked or toggled on, as shown here, the interactive map may be shown with the areas where Doppler data indicated that they did not receive any hail. As another example, a fifth selectable option 924 may be provided for the at least one radar characteristic representing hail size “greater than zero and less than 0.25 inches” 922. When the fifth selectable option 924 is clicked or toggled on, as shown here, the interactive map may be shown with the areas where Doppler data indicated that they received hail, but the hail sizes were less than 0.25 inches. When the fourth selectable option 920 and the fifth selectable option 924 are simultaneously toggled on, then the interactive map may be shown with the areas where Doppler data indicated that they did not receive hail, and the areas where Doppler data indicated that they received hail, but the hail sizes were less than 0.25 inches. Also, for example, a sixth selectable option 928 may be provided for the at least one radar characteristic representing hail size “greater than 0.25 inches and less than 0.50 inches” 926. When the sixth selectable option 928 is clicked or toggled on, as shown here, the interactive map may be shown with the areas where Doppler data indicated that they received hail, with hail sizes greater than 0.25 inches and less than 0.50 inches. Several more selectable options are illustrated for different hail sizes. It is significant to note that the key difference between Radar 916 and Hail Truth 900 is that Hail Truth 900 is based on field data whereas Radar 916 is based on weather radar data, such as data based on Doppler radar, and/or shape files from vendors.

FIG. 9C illustrates an example of a selectable option associated with a damage level. In some implementations the at least one attribute 900C may be the damage level 930. The damage level associated with a given object of the one or more objects may be indicative of a level of damage to the given object. In some implementations the damage level 930 may be provided for the one or more objects, the damage level 930 indicative of the level of damage to one or more objects based on at least one event characteristic. For example, in some implementations the damage level 930 may include a likelihood of no damage 932, with a corresponding selectable option 934; a likelihood of cosmetic damage 936, with a corresponding selectable option 938; a likelihood of repairable damage 940, with a corresponding selectable option 942; and a likelihood of functional damage 944, with a corresponding selectable option 946.

Cosmetic damage 936 includes temporary damage that may simply go away with time, and/or damage that may cause negligible loss of value to the one or more objects. For example, a wooden deck may receive temporary scratch marks from hail impact. For instance, the hail may be minimal in size to cause any real damage. When the corresponding selectable option 938 is selected, one or more objects, and/or a portion of the geographic area may be displayed representing cosmetic damage 936.

Repairable damage 940 may occur when the event causes damage to the one or more objects, but the damage may be repaired. For example, a few shingles on the roof may be damaged due to high wind, and replacing these damaged shingles may be sufficient to repair the roof. Also, for example, hail may impact a roof, but only portions such as ridge caps and valleys may have been impacted, beyond cosmetic damage. In such instances, the roof may be easily repaired. When the corresponding selectable option 942 is selected, one or more objects, and/or a portion of the geographic area may be displayed representing repairable damage 940.

Functional damage 944 may occur when the event causes damage to the one or more objects, and the damage is significant to cause functional failure of the utility of the damaged object. For example, high wind may have caused considerable damage to a roof such that replacing a few shingles may not make the roof functional. Also, for example, hail impact may be so great as to cause considerable damage to the roof. In such instances, the roof may need to be replaced. When the corresponding selectable option 946 is selected, one or more objects, and/or a portion of the geographic area may be displayed representing functional damage 944.

Providing the damage level 930 to an insurance provider is of considerable utility to the insurance provider. Such information allows the insurance provider to make better informed decisions for approval and denial of insurance claims. For example, when a property located in a target geographic area files a claim for roof replacement, the insurance provider may enter the corresponding address and view an image of the property at that address, with the associated damage level 930. The insurance provider may toggle on the selectable option 942 and the selectable option 946. If the property is in an area where there is functional damage 944, then the insurance provider may be better equipped to make the decision to approve the claim for roof replacement. On the other hand, if the property is in an area where there is repairable damage 942, the insurance provider may be better equipped to make the decision to deny the claim for roof replacement. In some instances, the insurance provider may take additional steps, such as send an insurance adjuster or request aerial photographs of the damage, to determine the actual extent of the damage before making such a decision to deny the claim for roof replacement. As described herein, the insurance company may use this data to validate insurance claims, and save time and resources by focusing their attention to further investigate claims that fall outside the reported damage area, or fall at or close to the boundary of the reported damage area. This substantially reduces the strains on the insurer's financial and human resources, while also ensuring a fast, reliable and efficient mechanism for the insured individual to have their legitimate claims authorized by the insurance company.

FIG. 9D illustrates an example of a selectable option associated with a confidence level. In some implementations the at least one attribute 900D may be the confidence level 950. As described herein, the confidence level 950 (or, equivalently, the confirmation level) may be associated with a damage assessment, and the confidence level may be indicative of confirmation of the field data. In some implementations the confidence level may be a combination of the number of witnesses who saw the event, their proximity to the event and their agreement to the details of the event. For example, a hundred witnesses at an adjacent apartment building may observe a boulder fall and impact a house. They may all agree that the boulder was 10 feet in diameter and fell 50 feet. Based on the number of witnesses and/or the consistency of their recollection of the observed event, a high confidence level may be associated with the event of the boulder falling and impacting the house. However, if only one witness observed the event and/or estimated the size and drop of the boulder, then the same event may be associated with a lower confidence level. In some implementations the confidence level may be represented as a confidence surface superimposed on the interactive map. In some implementations the boundaries of the regions of the confidence surface may be represented as contour lines. In some implementations the confidence level 950 may be represented by a score, a rating, a star system, and so forth. For example, the confidence level 950 may be represented as “Low” 952 representing a low degree of confidence, with an associated selectable option 954; the confidence level 950 may be represented as “Below Average” 956 representing a degree of confidence that is below average, with an associated selectable option 958; the confidence level 950 may be represented as “Average” 960 representing an average degree of confidence, with an associated selectable option 962; the confidence level 950 may be represented as “Above Average” 964 representing a degree of confidence that is above average, with an associated selectable option 966; and the confidence level 950 may be represented as “High” 968 representing a high degree of confidence, with an associated selectable option 970.

In some implementations the confidence level 950 may be based on field data. For example, the number of field data points may determine the confidence level 950. In some implementations a statistical distribution may be determined based on field data, and the confidence level may be based on such statistical distribution. For example, the field data points may be distributed on a target geographic area and regions of higher density of field data points may be associated with a confidence level that is greater than the confidence level that is associated with regions of lower density of field data points. Also, for example, a threshold may be determined and the number of field data points may be compared to the threshold to determine the confidence level. For example, if more than a thousand field data points are available, then the target geographic area may be associated with a high confidence level. As another example, the ratio of the number of field data points and the number of potentially affected objects may determine the confidence level. For example, a high ratio may be indicative of high confidence whereas a low ration may be indicative of low confidence.

In some implementations the confidence level for a point on the interactive map may depend on the distance of the point from the nearest field data point. For example, the confidence level associated with a point on the interactive map may be inversely proportional to its distance from a nearest field data point. For example, if field personnel have gathered field data from a house, then the damage assessment for other houses located in the immediate vicinity of the house may be associated with a high degree of confidence. For example, if a roof of a house has been inspected to have suffered functional damage from a hailstorm, there is a high degree of confidence that the nearby houses also suffered functional damage.

In some implementations the confidence level may be based on the target geographic area. For example, in a mountainous region the confidence level may depend on the particular side of the mountain a particular property is located. Damage assessments for properties within close proximity may have different confidence levels. For example, a side of a mountain may be eroded during heavy rainfall, and property located on that side may be damaged. However, another property in close proximity may not be damaged at all. In such instances, actual observation of the damage may contribute to determining the confidence level. Also, for example, accessibility to a target geographic area may impact the confidence level. An area that is easily accessible may be associated with a higher degree of confidence than an area that is inaccessible.

FIG. 9E illustrates another example of a selectable option associated with at least one attribute. In some implementations the at least one attribute 900E may include a number of preset options 972, with associated selectable options. For example, Hail Truth 972, Damage Likelihood 976, a first comparison 980 (e.g., Comp A≧1 inch) of a first radar characteristic and actual hail size of greater than 1 inch, a second comparison 982 (e.g., Comp A≧2 inches) of a first radar characteristic and actual hail size of greater than 2 inches, a third radar characteristic 984 (e.g., Comp B), may be provided. Additionally and/or alternatively, a selectable option to overlay one or more attributes onto the interactive map may be provided. For example, Sampling Points 988, Query Circles 990, and a PIF upload option 992 may be provided. The Query Circle 990 may indicate the boundary of the area from which field data may have been collected utilizing the one or more techniques disclosed herein. Sampling points 988 may represent the locations where homeowners, vendors, field personnel, and so forth may have provided field data.

Damage likelihood for the one or more objects may be provided, the damage likelihood indicative of a likelihood of damage to the given object. Damage likelihood may be based at least in part on the type of event, and the at least one event characteristic. As described herein, in the case of a hailstorm, the field data may record the different sizes of the hail in different parts of the target geographic area, the duration of the hailstorm, time duration and direction of wind speed, or the types of damage within the geographic area. For example, in certain parts within the geographic area, the resultant damage could be to the roof systems, and in certain other parts, the resultant damage could be to HVAC systems. In yet other parts, the damage could be to the walls of the residential or commercial property. Additionally, the degree and extent of damage inflicted in different parts of the targeted geographic area may vary depending on the size of the hail, the duration of the hailstorm, the wind speed, and the wind velocity. Field data collected may be customized to account for these varying factors. Damage likelihood may be calculated based on empirical data based on the collected field data. Damage likelihood may be provided as a numerical score, a rating, and so forth. For example, damage likelihood may be rated as “Low”, “Medium”, and “High”. For example, during a hailstorm, at least one event characteristic may include descriptors that include the size of hail, the duration of a hailstorm, wind speed, and/or wind direction, and these descriptors may then be correlated to the type and extent of damage to a roof based on logs of past disaster response and/or recovery efforts. This assessment may additionally factor in the type of roofing and the kind of roofing material used. The damage likelihood may be based at least in part on such factors.

In some implementations the PIF upload option 992 may indicate the properties that have policies in force with a particular insurance carrier. In many instances, the insurance provider may be reluctant to provide their PIF data. In such instances, the interactive map may be provided with geocoded data. The at least one attribute may be associated with the geocoded data. Additionally and/or alternatively, the insurance provider may be provided an option to upload their own PIF data and compare such PIF data with the geocoded data to identify the at least one attribute associated with their PIF data.

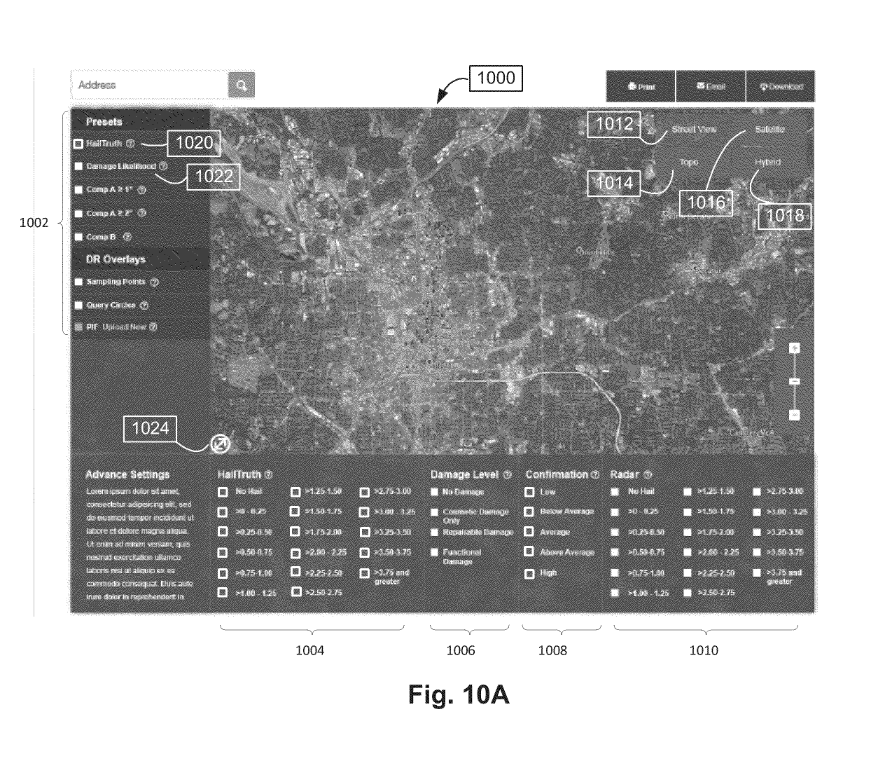

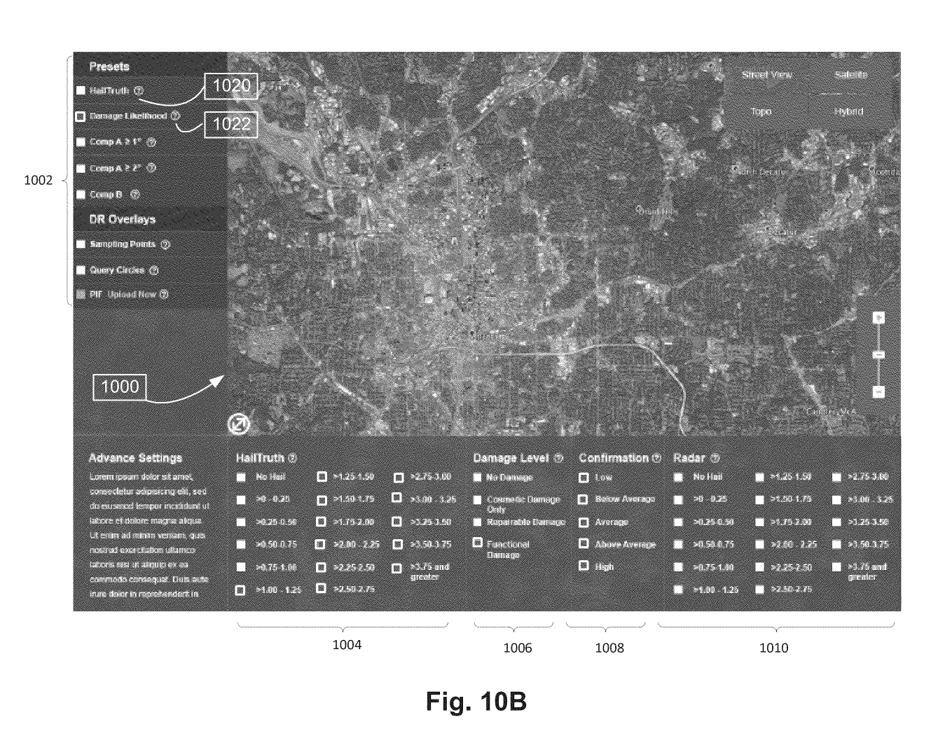

FIG. 10A illustrates an example of an interactive map including a selection of at least one attribute. The interactive map 1000 and selectable options for attributes are illustrated. As illustrated, included in the interactive map are presets and overlays 1002 (as described with reference to FIG. 9E), Hail Truth 1004 (as described with reference to FIG. 9A), damage level 1006 (as described with reference to FIG. 9C), confidence level 1008 (as described with reference to FIG. 9D), and Radar 1010 (as described with reference to FIG. 9B). The interactive map may also include an option to select a street view 1012, a topographic view 1014, a satellite view 1016, and a hybrid view 1018. The hybrid view 1018 may be a combination of map features of one or more of the street view 1012, the topographic view 1014, and the satellite view 1016. Also, an icon to maximize 1024 may be included in the interactive map. When the icon to maximize 1024 is selected, the interactive map 1000 may be displayed in full-screen mode. In some implementations such a full screen mode may not all the display of the selectable option for the attributes.

The presets and overlays 1002 may include one or more selectable options for the at least one event characteristic, such as Hail Truth 1020. In this figure, the selectable option associated with Hail Truth 1020 is illustrated as having been selected. Accordingly, the interactive map may be provided with data associated with the Hail Truth 1020. Also, for example, the selectable option associated with damage level 1006 is illustrated as having not been selected. Accordingly, the interactive map may not be provided with data associated with the damage level 1006.

FIG. 10B illustrates another example of an interactive map including a selection of at least one attribute. The interactive map 1000 and selectable options for attributes are illustrated. As illustrated, the attributes included in the interactive map are presets and overlays 1002 (as described with reference to FIG. 9E), Hail Truth 1004 (as described with reference to FIG. 9A), damage level 1006 (as described with reference to FIG. 9C), confidence level 1008 (as described with reference to FIG. 9D), and Radar 1010 (as described with reference to FIG. 9B). In this figure, the selectable option associated with Hail Truth 1020 is illustrated as having not been selected. Accordingly, the interactive map may not be provided with data associated with the Hail Truth 1020. Also, for example, the selectable option associated with damage level 1006 is illustrated as having been selected. Accordingly, the interactive map may be provided with data associated with the damage level 1006.

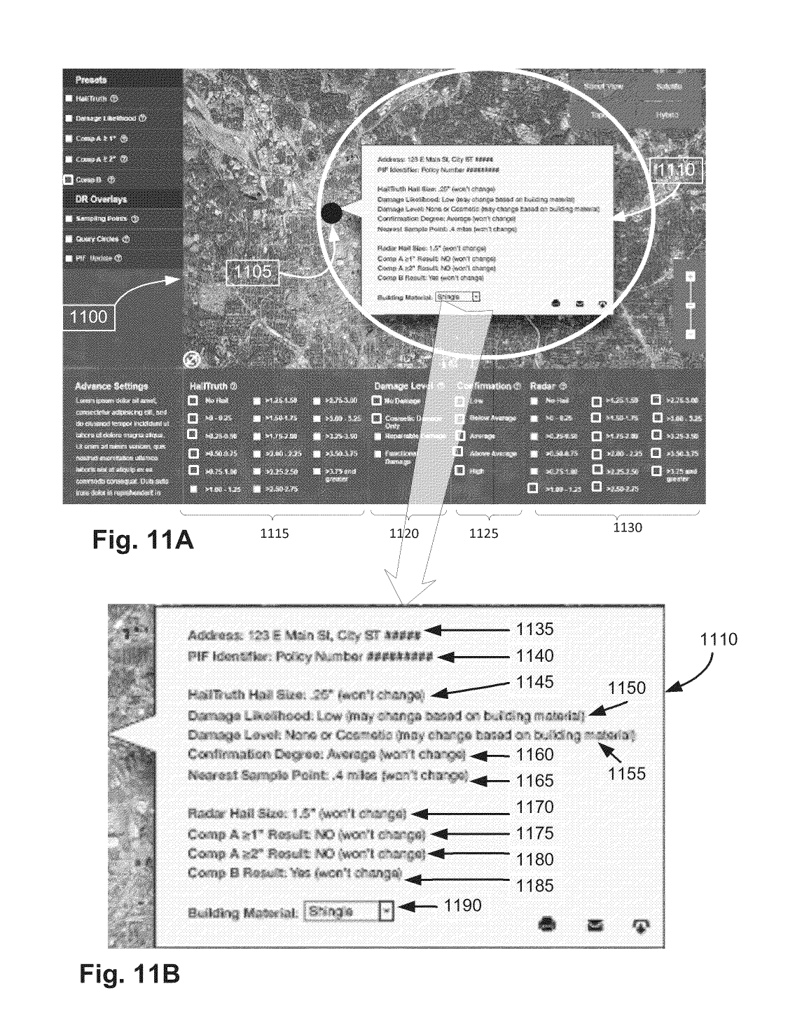

FIG. 11A illustrates an example of an interactive map including a report based on at least one attribute. The interactive map 1100 and selectable options for attributes are illustrated. As illustrated, the attributes Hail Truth 1115 (as described with reference to FIG. 9A), damage level 1120 (as described with reference to FIG. 9C), confidence level 1125 (as described with reference to FIG. 9D), and Radar 1130 (as described with reference to FIG. 9B).

A location 1105 is shown on the interactive map 1100. In some implementations, hovering over the location 1105, or clicking the interactive map 1100 at the location 1105 may display a pop-up report 1110 displaying information about location 1105.

In this figure, one or more selectable options associated with attributes are shown to have been selected. For example, in Hail Truth 1115, the selectable options associated with hail sizes in the range of “No Hail” to “1 in.” have been selected. Accordingly, the interactive map may be displayed with the areas corresponding to areas that received no hail and areas that received hail with sizes up to 1 inch. Also, for example, location 1105 may be displayed with information related to hail sizes in the range of “No Hail” to “1 inch”.

As another example, in damage level 1120, the selectable options associated with “No Damage” and “Cosmetic Damage only” have been selected. Accordingly, the interactive map may be displayed with the areas that received no damage and areas that received cosmetic damage only. Also, for example, location 1105 may be displayed with information related to damage levels associated with “No Damage” and “Cosmetic Damage only”. Also, for example, in Radar 1130, the selectable options associated with hail sizes greater than 1 inch have been selected. Accordingly, the interactive map may be displayed with the corresponding areas that were predicted to receive hail with hail sizes greater than 1 inch. Also, for example, location 1105 may be displayed with information related to areas that were predicted to receive hail with hail sizes greater than 1 inch.

In some implementations the selectable options may be provided as check boxes. In some implementations the selectable options may be provided in a sliding scale format, via a slider and/or radio dial. For example, in damage level 1120, the selectable option associated with “No Damage” may be selected. Also, for example, the selectable options associated with “No Damage” and “Cosmetic Damage only” may be selected. As another example, the selectable options associated with “No Damage”, “Cosmetic Damage only”, and “Repairable Damage” may be selected. Also, for example, the selectable options associated with “No Damage”, “Cosmetic Damage only”, “Repairable Damage”, and “Functional Damage” may be selected.

FIG. 11B illustrates an example report. For example, a magnified view of the report 1110 illustrated in FIG. 11A is shown here. The report 1110 may include an address 1135 associated with location 1105 in FIG. 11A. For example, the address 1135 may be “123 E. Main St, City ST #####”. In some implementations the PIF Identifier 1140 for the insurance policy associated with the property located at address 1135 may be displayed. The report 1110 may also include Hail Truth 1145 indicating that hail size of 0.20 inches was reported at the address 1135. The damage likelihood 1150 may indicate a low level of damage. For example, empirical evidence may be utilized to infer that the likelihood of damage to a roof from hail impact of hail size 0.20 inches is low. Such field data may be correlated to observed at least one event characteristic to determine the damage likelihood. Such data may be stored in or more databases.

The report 1110 may include an indication of the damage level 1155. For example, the damage level 1155 may be reported to be “No Damage”, or “Cosmetic Damage Only”. The confidence level 1160 associated with the attributes may be provided. For example, the confidence level 1160 may be reported to be “Average”. The distance of the nearest sample point 1165 may be provided as 1 mile.

Compared to the actual data, data based on the Doppler radar may also be included in report 1110. As described herein, generally speaking, one or more systems may be configured to receive signals from an independent weather data system about a past, current, imminent and/or potential disaster and identify a target geographic area based on these signals. In some implementations, the signals could be received from a source such as data provided by the National Oceanic and Atmospheric Administration (“NOAA”). Also, for example, the data may be obtained from a source such as NEXRAD weather data provided by the National Weather Service.

Comparison of field data and radar data may be displayed on the interactive map. For example, the Radar 1170 may have reported a hail size of 1.5 inches. A first comparison 1175, a second comparison 1180, and a third comparison 1185 may be reported from weather data systems, as described with reference to FIG. 9E. In some implementations a selectable menu option 1190 may be provided to identify one or more data related to one or more objects located at address 1135. For example, as illustrated, the type of roof for the property located at address 1135 may be specified as “Shingle” and the report 1110 may be generated based on such information. For example, the damage likelihood 1150 may be based on the type of roof.

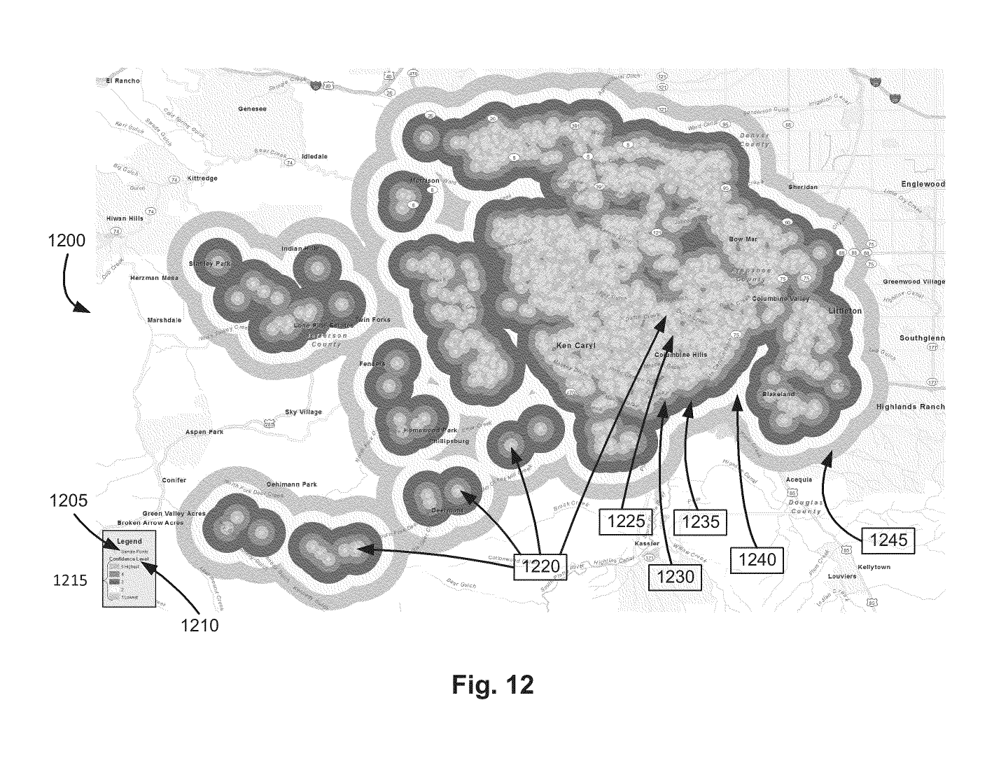

FIG. 12 illustrates an example of an interactive map including field data and a confidence level. An interactive map 1200 is illustrated. A legend describes that sample points 1205 are shown, as well as a Damage Level 1210 with one or more levels 1215, with level 1 corresponding to the lowest confidence level and level 5 corresponding to the highest confidence level. One or more sample points 1220 are illustrated on the interactive map 1200. Clicking on a sample point 1220 may generate a report as described with reference to FIGS. 11A and 11B. A confidence level 1210 may be determined based on the sample points 1220. For example, the first confidence level, “Level 5” 1225 may be associated with the area that is in close proximity to the sample points 1220. The confidence level 1210 may decrease as the distance from the sample points 1220 increases. For example, a second confidence level,

“Level 4” 1230 may be associated with the areas that are adjacent to the areas with confidence level, “Level 5” 1225, but further away from the sample points 1220 than the region with “Level 5” 1225 Likewise, areas with confidence levels corresponding to “Level 3” 1235, “Level 2” 1240, and “Level 1” 1245, may be determined. As indicated, the areas with a confidence level corresponding to “Level 1” 1245 may be the areas that are furthest away from the sample points 1220, and indicate the lowest level of confidence.

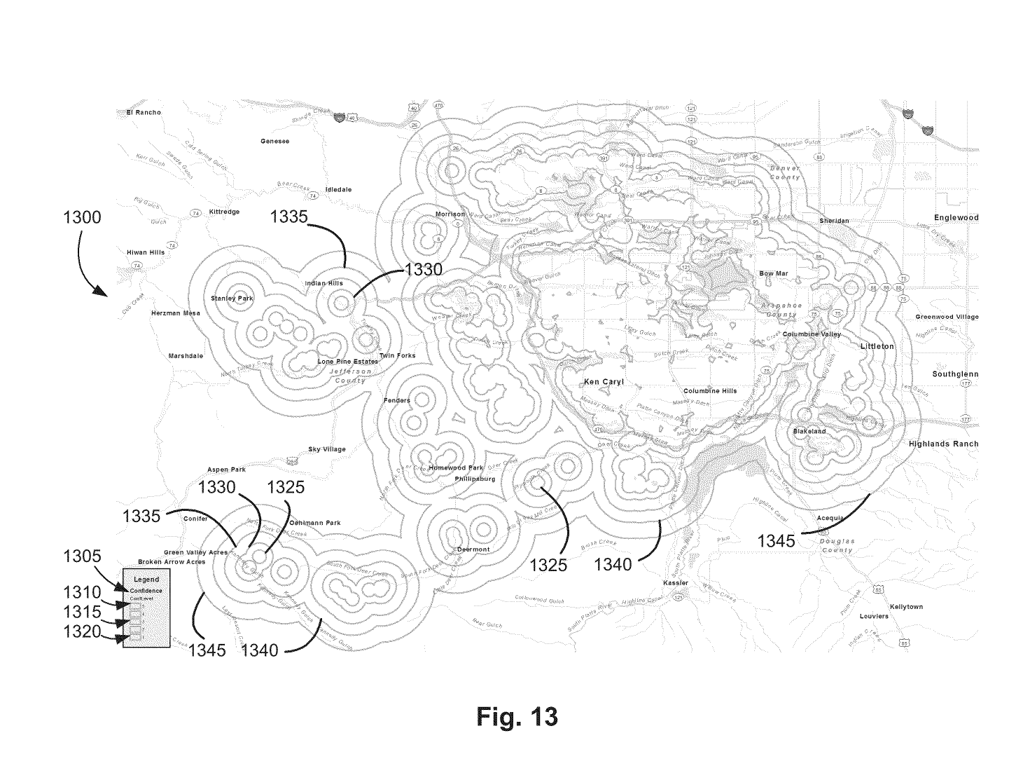

FIG. 13 illustrates an example of an interactive map including confidence levels represented as contour lines. An interactive map 1300 is illustrated. A legend describes Confidence Contour 1305 with one or more levels. For example, “Level 1” 1320 may correspond to the lowest confidence level, “Level 3” 1315 may correspond to a medium confidence level, and “Level 5” 1310 may correspond to the highest confidence level. In some implementations the contour lines may be the boundaries of the confidence regions described with reference to FIG. 12. For example, a first contour line 1325 may correspond to the boundary of the area associated with the first confidence level, “Level 5” 1225; a second contour line 1330 may correspond to the boundary of the area associated with the second confidence level, “Level 4” 1230; a third contour line 1335 may correspond to the boundary of the area associated with the third confidence level, “Level 3” 1235; a fourth contour line 1340 may correspond to the boundary of the area associated with the fourth confidence level, “Level 3” 1240; and a fifth contour line 1345 may correspond to the boundary of the area associated with the fifth confidence level, “Level 2” 1245.

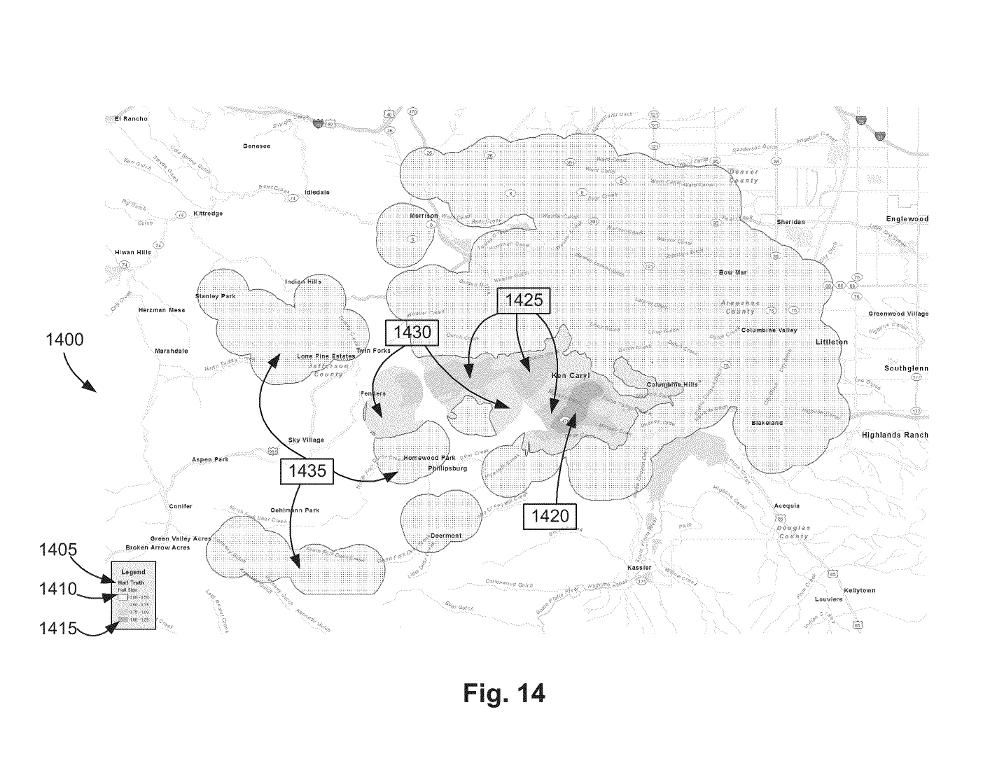

FIG. 14 illustrates an example of an interactive map including the at least one event characteristic. For example, the at least one event characteristic may be Hail Truth 1405 indicating the actual hail sizes. An interactive map 1400 is illustrated. A legend describes Hail Truth 1405 with one or more hail sizes. For example, a first range 1410 may correspond to hail sizes in the range “0.00 inches-0.50 inches”, and a second range 1415 may correspond to hail sizes in the range “1.00 inch-1.25 inches”. Regions corresponding to the hail sizes may be displayed on the interactive map 1400. For example, a first region 1420 may correspond to hail sizes in the range “1.00 inch-1.25 inches”; a second region 1425 may correspond to hail sizes in the range “0.75 inches-1.00 inch”; a third region 1430 may correspond to hail sizes in the range “0.50 inches-0.75 inches”; and a fourth region 1435 may correspond to hail sizes in the range “0.00 inches-0.50 inches”.

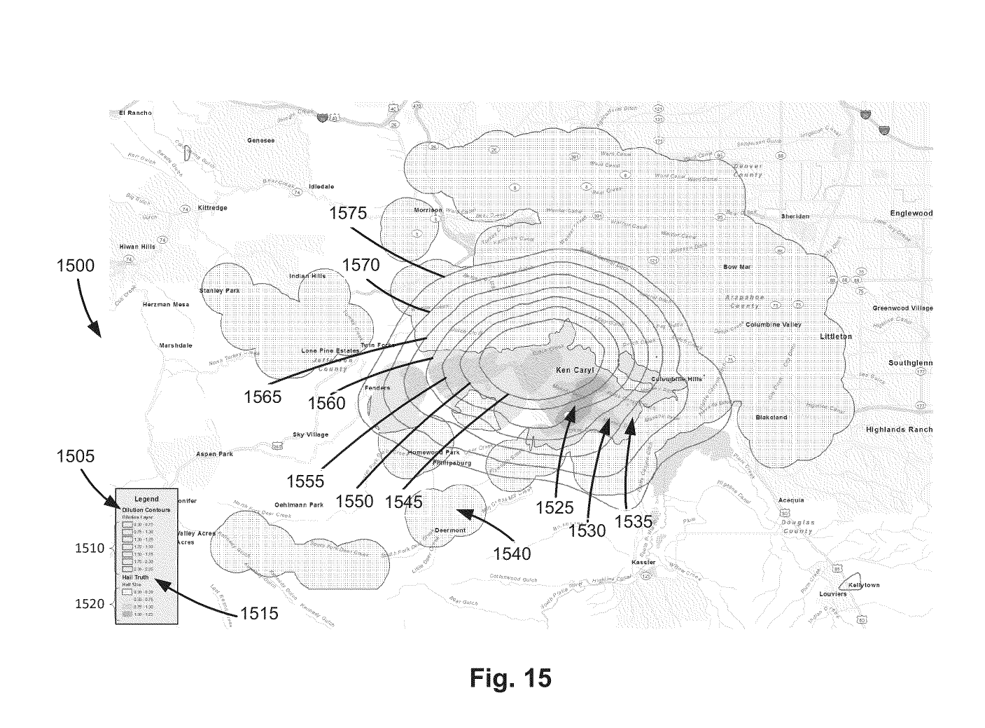

FIG. 15 illustrates an example of an interactive map including a comparison of at least one radar characteristic and at least one event characteristic. For example, a vendor may provide a shape file including a map with the at least one radar characteristic that is primarily based on Doppler data. In some implementations such information may not be an accurate representation of the ground truth. For example, based on Doppler data, the vendor may provide information to an insurance company that a first region received hail with hail sizes that were larger than, say 2 inches. Based on such data, the insurance company may make decisions related to approval and/or denial of insurance claims that may have been filed from the first region. However, based on one or more implementations described herein, the insurance company may have the option to compare the map from Doppler radar to a map based on field data. In some implementations the data from the weather radar may be masked via a dilution layer. For example, shape files available from a plurality of vendors may be combined to eliminate reference to the respective plurality of vendors. Such masked data may then be represented as a Dilution Contour, as described herein. The interactive map 1500 is obtained by superimposing the interactive map 1400 illustrated in FIG. 14 with the radar data.

A legend describes Dilution Contour 1505 with radar-based hail sizes 1510, and Hail Truth 1515 with actual hail sizes 1520. The image from the interactive map 1400 from FIG. 14 is shown. For example, a first region 1525 may correspond to hail sizes in the range “1.00 inch-1.25 inches”; a second region 1530 may correspond to hail sizes in the range “0.75 inches-1.00 inch”; a third region 1535 may correspond to hail sizes in the range “0.50 inches-0.75 inches”; and a fourth region 1540 may correspond to hail sizes in the range “0.00 inches-0.50 inches”. Superimposed over these regions may be the Dilution contour 1505. For example, a first dilution contour line 1545 may represent the boundary of the region with radar-based hail sizes in a first range indicated by the legend for the radar-based hail sizes 1510 Likewise, a second dilution contour line 1550 may represent the boundary of the region with radar-based hail sizes in a second range; a third dilution contour line 1555 may represent the boundary of the region with radar-based hail sizes in a third range; a fourth dilution contour line 1560 may represent the boundary of the region with radar-based hail sizes in a fourth range; and so forth.

A comparison of the respective hail sizes based on the radar-based data and the field data indicates the utility of such an interactive map 1500 to an insurance provider. For example, a provider of damage-related services to an insurance provider may provide hail data based on Doppler radar. However, the actual hail sizes may vary from the sizes indicated by the Doppler radar. Accordingly, the actual hail sizes would have an impact on both the damage level and the damage likelihood. For example, the first dilution contour line 1545 may represent the boundary of the region with radar-based hail sizes in the first range, say hail sizes greater than 2.50 inches. However, field data may indicate that the maximum reported hail sizes were in the range “1.00 inch-1.25 inches” represented by the first region 1525. The damage level from hail sizes greater than 2.50 inches may be functional damage, whereas the damage level from hail sizes in the range 1.00 inch-1.25 inches may be cosmetic damage. Accordingly, the insurance provider may be able to make better informed decisions on whether to approve or deny insurance claims from properties in the target geographic area.

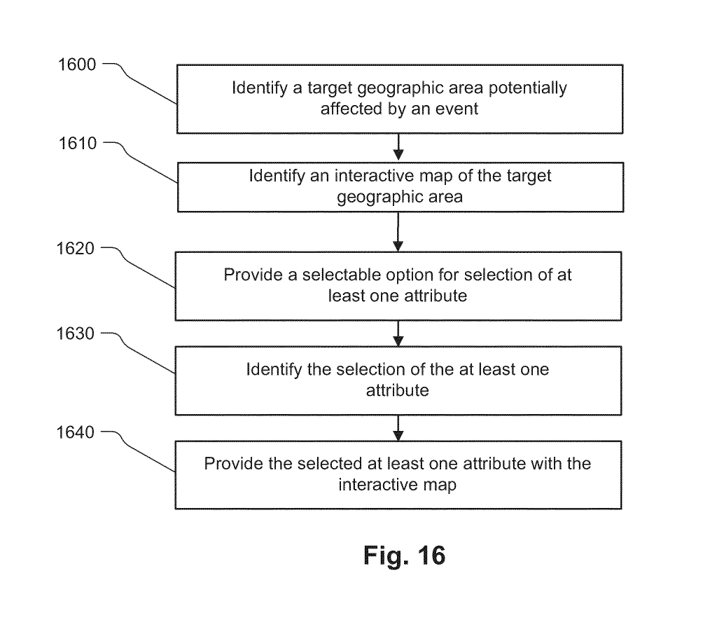

FIG. 16 illustrates a flow diagram of an example process for providing damage assessment.

At step 1600, a target geographic area may be identified, where the target geographic area may be potentially affected by an event. The target geographic area may include a physical location of a real property and/or a collection of real properties, a street, a highway, a region, a city, and so forth. In some implementations the target geographic area may be identified based on a query by a user. For example, the user may input data identifying the target geographic area. Also, for example, the user may select a portion of an interactive map to identify the target geographic area. In some implementations the target geographic area may be based on one or more of the event and a time period. For example, the event may be an ice storm in Atlanta, and the target geographic area may include the Greater Atlanta area. Also, for example, the event may be an earthquake in California, and the target geographic area may be portions of areas affected by the earthquake. As another example, the target geographic area may depend on the time period. For example, in response to the user's selection of a time period, the user may be provided with target geographic areas where potential damage may have been reported and/or forecast. The event may include one or more of a thunderstorm, rain, tornado, snowstorm, hailstorm, hurricane, landslide, sinkhole, erosion, avalanche, lightning, drought, wind, fire, smoke, ash, earthquake, tsunami, floods, volcano eruption, war, spill, release, train derailment, automobile crash, airplane crash, and stampede. For the purposes of this disclosure, the terms “disaster event” and “event” have been interchangeably used, and these terms must be construed in their broadest sense to include any event that may lead to a possibility of damage assessment. As described herein, a “disaster event” and/or an “event” may include non-disaster events such as a hailstorm, heavy rains, an automobile stuck in the mud, a minor earthquake, and so forth. On the other hand, a “disaster event” and/or an “event” may include events that may rise to the level of a “disaster” (e.g., a federally declared disaster) such as a major earthquake, a tsunami, and so forth. It will be apparent to a person of ordinary skill that the present disclosure is directed at providing attributes related to potential damage, and such attributes and/or potential damage may arise from many events. All such events are contemplated to be included within the meaning of the terms “disaster event” and/or “event”.

At step 1610, an interactive map of the target geographic area may be identified. The interactive map may include a one or more menus, icons, and legends. In some implementations one or more legends associated with the at least one attribute may be provided, where the one or more legends describe properties of the at least one attribute. The interactive map may also include embedded data including photographs, drawings, graphics designs, maps, engineering drawings, or other images. The interactive map may be capable of visual presentation on a computer screen. In some implementations identifying the interactive map may include retrieving the interactive map from a database via a computer network. For example, the user may submit a query for a target geographic region and an interactive map of the target geographic region may be retrieved from a database. In some implementations the database may be included in the central command module 120, such as central command database 220, weather data system database 270, and/or mapping service 280. In some implementations one or more of geocoded data and data based on insurance policies-in-force may be uploaded onto the interactive map. In some implementations an option to upload one or more of the geocoded data and the data based on the insurance policies-in-force may be provided. In some implementations, in response to receipt of an affirmative selection of the option to display one or more of the geocoded data and the data based on the insurance policies-in-force, the one or more of the geocoded data and the data based on the insurance policies-in-force may be displayed.

In some implementations the interactive map of the target geographic area may include one or more of a satellite image, an aerial image, a street view, topographic view. In some implementations the aerial image may be based on image data from one or more of a fixed wing aircraft, a rotating wing aircraft, an unmanned aerial vehicle (“UAV”) such as a drone, and a balloon (e.g., a weather balloon). In some implementations the image data may include a video. For example, the UAV may provide a video of the one or more objects in the target geographic area and such video may be included in the interactive map of the target geographic area.

At step 1620, a selectable option for selection of at least one attribute may be provided. The at least one attribute including one or more of at least one radar characteristic based on data from weather radar, at least one event characteristic associated with the event, at least one event characteristic based on field data, data related to one or more objects in the target geographic area, at least one damage characteristic associated with a given object of the one or more objects, the at least one damage characteristic identifying potential damage to the given object based on the event, a damage likelihood associated with the given object, the damage likelihood indicative of a likelihood of damage to the given object, a damage level associated with the given object, the damage level indicative of a level of damage to the given object, and a confidence level associated with the damage assessment, the confidence level indicative of confirmation of the field data.

The at least one radar characteristic may be based on data from any form of weather radar, including Doppler radar. For example, in some implementations the at least one radar characteristic may be based on one or more of Doppler radar data, pulse-Doppler radar data, data from a provider of weather-related services, and data from a provider of disaster-related services. In some implementations the at least one radar characteristic may be a radar map of the target geographic area. In some implementations the event may be a hail storm, and the at least one radar characteristic may be a distribution of hail sizes, based on data from weather radar. In some implementations the at least one radar characteristic may include shape files from a vendor.

The at least one event characteristic associated with the event may be based on field data. The field data, for example the actual hail size, may be received from one or more sources, including data from field personnel deployed in the target geographic area. Also, for example, phone surveys may be conducted in the target geographic area, and information pertaining to actual hail size (e.g., ranges of hail sizes), duration of the hail event, observed damage, and so forth may be collected. Generally, the at least one event characteristic may include ranges for hail size, wind speed, wind direction, vehicle speed, weather conditions, temperature, humidity, visibility, and road conditions. In some implementations the event may be a hail storm, and the at least one event characteristic may be a distribution of hail sizes based on the field data.

The one or more objects may include one or more of a single real property, a collection of real properties, a vehicle, a train, a ship, an airplane, an oil rig, etc. The data related to the one or more objects may be based on one or more of an address, zip code, county, city, state, street, insurance provider, property value, and property type. The data related to the one or more objects may include photographs, drawings, graphics designs, engineering drawings, or other images. For example, the data related to the one or more objects may be a video of a house being swept away in a flood. Also, for example, the data related to the one or more objects may be images of the roof of a house, before and after images of a physical area including the object (e.g., before and after images of a landslide, a sinkhole). As another example, the object may be a vehicle, and the data related to the object may be its make, model, year, VIN number, and so forth. Also, for example, the data related to the one or more objects may include location data, such as GPS data, a lat/lon data, and so forth.

The at least one damage characteristic may be associated with a given object of the one or more objects, where the at least one damage characteristic identifies potential damage to the given object based on the event. For example, the at least one damage characteristic may be one or more of a type and extent of physical damage to a roof of a residential property. Also, for example, the at least one damage characteristic may be any damage resulting from wind, fire, smoke, ash, lightning, flood, and so forth. In some implementations the at least one damage characteristic may be based on the field data. For example, reports based on phone surveys may indicate the type and extent of damage. In some implementations the event may be a hail storm and the at least one damage characteristic may be based on the hail size. In some implementations the event may be a hail storm and the at least one damage characteristic may be based on one or more of wind direction and wind speed.

The damage likelihood associated with the given object may be indicative of a likelihood of damage to the given object. Damage likelihood may be based on the type of event, and the event characteristics. As described herein, in the case of a hailstorm, the field data may record the different sizes of the hail in different parts of the target geographic area, the duration of the hailstorm, time duration and direction of wind speed, or the types of damage within the geographic area. For example, in certain parts within the geographic area, the resultant damage could be to the roof systems, and in certain other parts, the resultant damage could be to HVAC systems. In yet other parts, the damage could be to the walls of the residential or commercial property. Additionally, the degree and extent of damage inflicted in different parts of the targeted geographic area may vary depending on the size of the hail, the duration of the hailstorm, the wind speed, and the wind velocity. Field data collected may be customized to account for these varying factors. Damage likelihood may be calculated based on empirical data based on the collected field data. Damage likelihood may be provided as a numerical score, a rating, and so forth. For example, damage likelihood may be rated as “Low”, “Medium”, and “High”.

The damage level associated with the given object may be indicative of a level of damage to the given object. For example, in some implementations the damage level may include a likelihood of no damage, a likelihood of cosmetic damage, a likelihood of repairable damage, and a likelihood of functional damage. Cosmetic damage may include temporary damage that may simply go away with time, and/or damage that may cause negligible loss of value to the one or more objects. For example, a wooden deck may receive temporary scratch marks from hail impact. Repairable damage may occur when the event causes damage to the one or more objects, but the damage may be repaired. For example, a few shingles on the roof may be damaged due to high wind, and replacing these damaged shingles may be sufficient to repair the roof. Functional damage may occur when the event causes damage to the one or more objects, and the damage is significant to cause functional failure of the utility of the damaged object. For example, high wind may have caused considerable damage to a roof such that replacing a few shingles may not make the roof functional.

The confidence level associated with the damage assessment may be indicative of confirmation of the field data. In some implementations the confidence level may be a combination of one or more of the event, target geographic area, number of observers of the event, proximity of the observers to the event, agreement among the observers to details of the event, and length of elapsed time after the event. For example, a hundred witnesses at an adjacent apartment building may observe a boulder fall and impact a house. They may all agree that the boulder was 10 feet in diameter and fell 50 feet. Based on the number of witnesses and/or the consistency of their recollection of the observed event, a high confidence level may be associated with the event of the boulder falling and impacting the house. However, if only one witness observed the event and/or estimated the size and drop of the boulder, then the same event may be associated with a lower confidence level.

In some implementations the confidence level may be represented as a confidence surface superimposed on the interactive map. In some implementations the boundaries of the regions of the confidence surface may be represented as contour lines. In some implementations the confidence level may be represented by a score, a rating, a star system, and so forth. For example, the confidence level may be represented as “Low”, representing a low degree of confidence; as “Below Average”, representing a degree of confidence that is below average; as “Average”, representing an average degree of confidence; as “Above Average”, representing a degree of confidence that is above average; and as “High”, representing a high degree of confidence.

Selectable options may be provided for the at least one attribute. In some implementations the selectable options may be provided as check boxes. In some implementations the selectable options may be provided in a sliding scale format, via a slider and/or radio dial. Also, for example, selectable options may be provided in the form of menus, icons, fields that may be toggled on or off, hyperlinks, and so forth. In some implementations the selectable option for selection of the at least one attribute may include an option to select a time period. The interactive map and the target geographic area may be based on the selection of the time period. Also, for example, the at least one attribute may be updated from time to time, and selection of the time period may allow the user to view prior versions of the at least one attribute.

At step 1630, the selected at least one attribute may be identified. The computing device may be configured to identify selection of the at least one attribute. For example, when the selectable option is provided as a check box, then user selection of the check box may be identified. In some implementations the selection may be identified via one or more of a mouse click, a click-through, an audio selection, and a selection by a user's finger on a touch-sensitive input device. In some implementations identifying the selection of the at least one attribute may include receiving a query related to the at least one attribute. In some implementations receiving the query related to the at least one attribute may include identifying a selection of a portion of the interactive map. In some implementations the selection of the portion of the interactive map may include one or more of a mouse click, a click-through, an audio selection, and a selection by a user's finger on a touch-sensitive input device.

At step 1640, the selected at least one attribute may be provided with the interactive map. For example, the selectable options associated with the at least one radar characteristic may be selected, and the at least one radar characteristic may be provided. In some implementations the at least one attribute may be provided in combination with another at least one attribute. For example, the selectable options associated with the at least one radar characteristic and the at least one event characteristic may be selected, and both the at least one radar characteristic and the at least one event characteristic may be provided. Also, for example, the at least one radar characteristic may be provided in the form of a shape file from the vendor, and the at least one damage characteristic may be provided with the shape file from the vendor. In some implementations a comparison of the at least one radar characteristic and the at least one event characteristic may be provided. Also, for example, the user may click on a house located in the target geographic area, and one or more of the damage characteristics, damage level, and damage likelihood may be provided for that house. In some implementations image data based on aerial images (e.g., from a UAV) may be provided with the selected at least one attribute.

In some implementations identifying an interactive map may include identifying a portion of an interactive map, and providing the selected at least one attribute may include providing the selected at least one attribute for the identified portion of the interactive map. For example, a grid may be identified on an interactive map, and the at least one attribute may be provided for the identified grid. As described herein, the grid may include, for example, a 5 mile-by-5 mile portion of the target geographic area. Also, for example, the grid may include a portion represented by a collection of city blocks. Additional and/or alternative embodiments of a grid may be utilized, such as based on ranges of lat/lon coordinates, and/or GPS coordinates.

In some implementations providing the selected at least one attribute may include retrieving the selected at least one attribute from a database via a computer network. In some implementations providing the selected at least one attribute may include retrieving the selected at least one attribute from a database in the computing device. In some implementations providing the selected at least one attribute may include texturing the interactive map with the selected at least one attribute. Generally, texturing is a method for adding detail, including text and/or illustration, surface texture, and/or color to a computer-generated graphic, such as the interactive map. In some implementations providing the selected at least one attribute may include displaying the at least one attribute as one or more of a contour map and a topographic surface. In some implementations the at least one attribute may be provided as an animated image. In some implementations the at least one attribute may be provided with a report. The report may be provided in the form of a drop down menu, a pop-up, a downloadable and/or printable electronic document. Additional and/or alternative methods of electronic delivery may be utilized.

In some implementations providing the selected at least one attribute may include displaying the selected at least one attribute on a computing device. The computing device may be a desktop, a mobile device, and so forth. In some implementations the mobile device may be a wearable computing device (e.g., a watch, glasses). In some implementations the mobile computing device may be a laptop, a smartphone, and/or any other mobile computing device capable of displaying the selected at least one attribute.

It is understood that these examples are intended in an illustrative rather than in a limiting sense. Computer-assisted processing is implicated in the described embodiments. It is contemplated that modifications and combinations will readily occur, which modifications and combinations will be within the scope of the following claims.

What is claimed is:

1. A computer implemented method, comprising:
identifying, via one or more servers, a target geographic area potentially affected by an event;
identifying, via one or more servers, an interactive map of the target geographic area;
providing a selectable option for selection of at least one attribute, the at least one attribute including one or more of:
at least one radar characteristic based on data from weather radar,
at least one event characteristic associated with the event, the at least one event characteristic based on field data,
data related to one or more objects in the target geographic area,
at least one damage characteristic associated with a given object of the one or more objects, the at least one damage characteristic identifying potential damage to the given object based on the event,
a damage likelihood associated with the given object, the damage likelihood indicative of a likelihood of damage to the given object,
a damage level associated with the given object, the damage level indicative of a level of damage to the given object,
a confidence level associated with a damage assessment, the confidence level indicative of confirmation of the field data;
identifying the selection of the at least one attribute; and
providing, in response to the selection of the at least one attribute, the selected at least one attribute with the interactive map.

2. The method of claim 1, wherein identifying the interactive map includes retrieving, via a computer network, the interactive map from a database.

3. The method of claim 1, wherein providing the selected at least one attribute includes retrieving, via a computer network, the selected at least one attribute from a database.

4. The method of claim 1, wherein providing the selected at least one attribute includes texturing the interactive map with the selected at least one attribute.

5. The method of claim 1, further including providing an option to upload one or more of geocoded data and data based on insurance policies-in-force.

6. The method of claim 5, further including:
receiving an affirmative selection of the option to display one or more of the geocoded data and the data based on the insurance policies-in-force; and
displaying, in response to the affirmative selection of the option to display, the one or more of the geocoded data and the data based on the insurance policies-in-force.

7. The method of claim 1, wherein the at least one damage characteristic is based on the field data.

8. The method of claim 1, wherein the data related to the one or more objects is based on one or more of an address, zip code, county, city, state, street, insurance provider, property value, and property type.

9. The method of claim 1, further including providing one or more legends associated with the at least one attribute, the one or more legends describing properties of the at least one attribute.

10. The method of claim 1, wherein the one or more objects is a residential property, and the at least one damage characteristic is one or more of a type and extent of physical damage to a roof of the residential property.

11. The method of claim 1, wherein the at least one damage characteristic is based on the field data.

12. The method of claim 1, wherein the event is a hail storm and the at least one damage characteristic is based on the hail size.

13. The method of claim 1, wherein the event is high wind and the at least one damage characteristic is based on one or more of wind direction and wind speed.

14. The method of claim 1, wherein the event is a hail storm, and the at least one radar characteristic is a distribution of hail sizes based on data from the weather radar.

15. The method of claim 1, wherein the event is a hail storm, and the at least one event characteristic is a distribution of hail sizes based on the field data.

16. The method of claim 1, further including providing a comparison of the at least one radar characteristic and the at least one event characteristic.

17. The method of claim 1, wherein the confidence level is based on one or more of the event, target geographic area, number of observers of the event, proximity of the observers to the event, agreement among the observers to details of the event, and length of elapsed time after the event.

18. The method of claim 1, wherein providing the selected at least one attribute includes displaying the at least one attribute as one or more of a contour map and a topographic surface.

19. The method of claim 1, wherein the selectable option for the selection of the at least one attribute includes an option to select a time period.

20. The method of claim 1, wherein identifying the selection of the at least one attribute includes receiving a query related to the at least one attribute.

21. The method of claim 20, wherein receiving the query related to the at least one attribute includes identifying a selection of a portion of the interactive map.

22. The method of claim 21, wherein the selection of the portion of the interactive map includes one or more of a mouse click, a click-through, an audio selection, and a selection by a user's finger on a touch-sensitive input device.

23. The method of claim 1, wherein the at least one attribute is an interactive graphic attribute.

24. The method of claim 1, wherein the interactive map of the target geographic area includes one or more of a satellite image, an aerial image, a street view, topographic view.

25. The method of claim 24, wherein the aerial image is based on image data from one or more of a fixed wing aircraft, a rotating wing aircraft, an unmanned aerial vehicle, and a balloon.

26. The method of claim 25, wherein the image data includes a video.

27. The method of claim 1, wherein the event includes one or more of a thunderstorm, rain, tornado, snowstorm, hailstorm, hurricane, landslide, sinkhole, erosion, avalanche, lightning, drought, wind, fire, smoke, ash, earthquake, tsunami, floods, volcano eruption, war, spill, release, train derailment, automobile crash, airplane crash, and stampede.

28. The method of claim 1, wherein the field data includes data from one or more of phone surveys and field personnel deployed in the target geographic area.

29. The method of claim 1, further including providing a report based on the at least one attribute.

30. The method of claim 1, wherein said target geographic area is based on one or more of the event and a time period.

31. The method of claim 1, wherein providing the selected at least one attribute includes displaying the selected at least one attribute on a computing device.

32. The method of claim 31, wherein the computing device is a mobile computing device.

33. A system including memory and one or more processors operable to execute instructions stored in the memory, comprising instructions to:
identify a target geographic area potentially affected by an event;
identify an interactive map of the target geographic area;
provide a selectable option for selection of at least one attribute, the at least one attribute including one or more of:
at least one radar characteristic based on data from weather radar,
at least one event characteristic associated with the event, the at least one event characteristic based on field data,
data related to one or more objects in the target geographic area,
at least one damage characteristic associated with a given object of the one or more objects, the at least one damage characteristic identifying potential damage to the given object based on the event,
a damage likelihood associated with the given object, the damage likelihood indicative of a likelihood of damage to the given object,
a damage level associated with the given object, the damage level indicative of a level of damage to the given object,
a confidence level associated with a damage assessment, the confidence level indicative of confirmation of the field data;
identify the selection of the at least one attribute; and
provide, in response to the selection of the at least one attribute, the selected at least one attribute with the interactive map.

34. The system of claim 33, wherein the instructions to identify the interactive map include instructions to retrieve the interactive map from a database.

35. The system of claim 33, wherein the instructions to provide the selected at least one attribute include instructions to retrieve the selected at least one attribute from a database.

36. The system of claim 33, wherein the instructions to the selected at least one attribute include instructions to texture the interactive map with the selected at least one attribute.

37. The system of claim 33, further including instructions to provide an option to upload one or more of geocoded data and data based on insurance policies-in-force.

38. The system of claim 37, further including instructions to:
receive an affirmative selection of the option to display one or more of the geocoded data and the data based on the insurance policies-in-force; and
display, in response to the affirmative selection of the option to display, the one or more of the geocoded data and the data based on the insurance policies-in-force.

39. The system of claim 33, further including instructions to provide one or more legends associated with the at least one attribute, the one or more legends describing properties of the at least one attribute.

40. The system of claim 33, further including instructions to provide a comparison of the at least one radar characteristic and the at least one event characteristic.

41. A non-transitory computer readable storage medium storing computer instructions executable by a processor to perform a method comprising:
identifying a target geographic area potentially affected by an event;
identifying an interactive map of the target geographic area;
providing a selectable option for selection of at least one attribute, the at least one attribute including one or more of:
at least one radar characteristic based on data from weather radar,
at least one event characteristic associated with the event, the at least one event characteristic based on field data,
data related to one or more objects in the target geographic area,
at least one damage characteristic associated with a given object of the one or more objects, the at least one damage characteristic identifying potential damage to the given object based on the event,
a damage likelihood associated with the given object, the damage likelihood indicative of a likelihood of damage to the given object,
a damage level associated with the given object, the damage level indicative of a level of damage to the given object,
a confidence level associated with a damage assessment, the confidence level indicative of confirmation of the field data;
identifying the selection of the at least one attribute; and
providing, in response to the selection of the at least one attribute, the selected at least one attribute with the interactive map.
